(19) United States
(12) Patent Application Publication
(10) Pub. No.: US 2025/0292604 A1
(43) Pub. Date: Sep. 18, 2025

(54) CONSENSUS LABELING IN DIGITAL PATHOLOGY IMAGES

(71) Applicant: Ventana Medical Systems, Inc., Tucson, AZ (US)

(72) Inventors: Mohammad Saleh MIRI, San Jose, CA (US); Desika SELVARAJ, Bangalore (IN)

(73) Assignee: Ventana Medical Systems, Inc., Tucson, AZ (US)

(21) Appl. No.: 19/224,470

(22) Filed: May 30, 2025

Related U.S. Application Data
(63) Continuation of application No. PCT/US2023/081201, filed on Nov. 27, 2023.
(60) Provisional application No. 63/385,837, filed on Dec. 2, 2022.

(51) Int. Cl. G06V 20/70; G06V 10/762; G06V 10/764; G06V 10/774; G06V 10/776; G06V 20/69

(52) U.S. Cl. CPC G06V 20/70; G06V 10/763; G06V 10/764; G06V 10/774; G06V 10/776; G06V 20/698; G06V 2201/03

(57) ABSTRACT

The present disclosure relates to systems and methods for determining a consensus location and label for a set of annotations associated with an object or region within an image. An annotation-processing system can access a plurality of annotations associated with the image depicting at least part of a biological sample. The annotation-processing system can determine a consensus location for a set of annotations that are positioned in different locations within a region of the image. At the determined consensus location, a consensus label can be determined for the set of annotations that identify different targeted types of biological structures. The consensus labels across different locations can be used to generate ground-truth labels for the image. The ground-truth labels can be used to train a machine-learning model configured to predict different types of biological structures in digital pathology images.

### CROSS REFERENCE TO RELATED APPLICATIONS

This application is a continuation of International Patent Application No. PCT/US2023/081201, filed on Nov. 27, 2023, which claims priority under PCT Article 8 and Rule 4.10 to U.S. Provisional Patent Application No. 63/385,837 filed on Dec. 2, 2022. The entire disclosures of the aforementioned applications are incorporated by reference herein in their entireties for all purposes.

### FIELD

This disclosure generally relates to generating ground-truth labels for images used for training, validating, or testing a machine-learning model. More specifically, but not by way of limitation, this disclosure relates to generating consensus ground-truth labels for the images.

### BACKGROUND

In digital pathology platforms, machine-learning models can be used to predict a cell type for various cells depicted on a slide image. The targeted cell type for a cell can include a tumor cell, an immune cell, a stromal cell, and so on. The machine-learning models can be trained to predict the cell types based on a training dataset that includes a plurality of training images. Each training image can include a set of ground-truth labels, in which a ground-truth label identifies a target cell type of a cell at a corresponding location of the training image. The set of ground-truth labels can include one or more target classifications, such that the machine-learning models learn to predict one of the target classifications for various cells detected in the slide image. The set of ground-truth labels is typically provided by one or more experts (e.g., pathologists).

Providing accurate ground-truth labels, however, can be challenging. For example, a first pathologist can consider a particular cell as corresponding to a first cell type (e.g., an immune cell), but a second pathologist can consider the same particular cell as corresponding to a second cell type (e.g., a tumor cell). These different observations may propagate to all other cells that are depicted in the training image, thus resulting in training data that include conflicting ground-truth labels. Such training data can include additional annotation conflicts as additional experts can be used to provide the ground-truth labels across various training images. If such training data is used for training, the machine-learning models may not learn properly and thus perform inconsistently during the inference phase (i.e., during deployment). As a result, classification accuracy of the trained machine-learning models can decrease.

### SUMMARY

Techniques described herein relate to determining a consensus location and label for a set of annotations associated with an object or region within an image. An annotation-processing system can access a plurality of annotations associated with the image depicting at least part of a biological sample. The annotation-processing system can determine a consensus location for a set of annotations that are positioned in different locations within a region of the image. At the determined consensus location, a consensus label can be determined for the set of annotations that identify different targeted types of biological structures. The consensus labels across different locations can be used to generate ground-truth labels for the image.

In some embodiments, a system is provided that includes one or more data processors and a non-transitory computer readable storage medium containing instructions which, when executed on the one or more data processors, cause the one or more data processors to perform part or all of one or more methods disclosed herein.

In some embodiments, a computer-program product is provided that is tangibly embodied in a non-transitory machine-readable storage medium and that includes instructions configured to cause one or more data processors to perform part or all of one or more methods disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Aspects and features of the various embodiments will be more apparent by describing examples with reference to the accompanying drawings, in which:

FIG. 1 shows an example schematic diagram that illustrates a process for generating consensus labels for a slide image, according to some embodiments.

FIG. 2 shows an exemplary network for generating digital pathology images in accordance with various embodiments.

FIG. 3 shows an exemplary computing environment for processing digital pathology images using a machine learning/deep learning model in accordance with various embodiments.

FIG. 4 shows a schematic diagram that illustrates a process for identifying clusters for a set of annotations for a slide image, according to some embodiments.

FIG. 5 shows an example image that includes locations of the annotations, according to some embodiments.

FIG. 6 shows an example set of annotations identified in a training slide image, according to some embodiments.

FIG. 7 shows example images that illustrate a process in which annotation conflicts are resolved, according to some embodiments.

FIG. 8 shows another set of example images that illustrate a process in which annotation conflicts are removed, according to some embodiments.

FIG. 9 illustrates a process for identifying annotation-location conflicts in an image, in accordance with some embodiments.

FIG. 10 illustrates a process for removing annotation-location conflicts and determining consensus labels in an image, in accordance with some embodiments.

FIG. 11 illustrates a schematic diagram that describes a process for removing annotation-label conflicts and determining a consensus label for an image, according to some embodiments.

FIG. 12 illustrates an example image that includes that consensus labels and locations, according to some embodiments.

FIG. 13 illustrates a schematic diagram that describes a process for removing annotation-label conflicts and determining a consensus label for an image, according to some embodiments.

### DETAILED DESCRIPTION

Existing techniques can generally remove annotation conflicts by: (i) receiving annotations from multiple pathologists for a given image region; and (ii) determining a single label for the image region based on a majority of the annotations indicating a particular type of biological structure. However, the above existing techniques may become ineffective when it is unclear as to whether one or more annotations correspond to the same image region or image object (e.g., cell). For example, although the pathologists are instructed to annotate a cell by placing a point in the center of a cell, the annotations can be unintentionally added (i.e., placed) at various locations that do not correspond to the cell center. In another example, some annotations may not be added in an image region at all, because one or more pathologists may consider the image region as not depicting a cell. Accordingly, it is challenging to determine accurate ground-truth labels for images based on processing the annotations, due to the annotations being inconsistently added or not added at different locations of the images.

Certain embodiments described herein can address these problems and others by determining a consensus location for a set of annotations that are positioned in different locations within a region of an image. The image can be part of a training dataset used for training a machine-learning model. In some instances, the image is part of a validation dataset used for validating the machine-learning model. Additionally or alternatively, the image can be part of a test dataset used for testing the machine-learning model. For the determined consensus location, a consensus label can be determined for the set of annotations that identify different targeted types and/or locations of biological structures. The consensus labels across different locations can be used to generate ground-truth labels for the image. The ground-truth labels can be used to train a machine-learning model configured to predict different types and/or locations of biological structures in digital pathology images. In effect, the determination of the consensus locations and labels can increase consistency and accuracy of generating ground-truth labels for training machine-learning models.

An annotation-processing system can access a plurality of annotations associated with a image depicting at least part of a biological sample. As an illustrative example, the image can be a digital pathology image depicting at least part of a lung tissue sample obtained from a subject. The plurality of annotations can be used to generate ground-truth labels for supervised training of a machine-learning model, in which each annotation can include: (i) a location that identifies an object or region within the image; (ii) a targeted type of biological structure for the object or region; and (iii) an identifier associated with an annotator (e.g., a pathologist) that generated the annotation. Continuing with the above example, the annotation-processing system can receive annotations generated by a team of pathologists (e.g., four pathologists) for the image. An annotation in this example can include a set of x-y coordinates that identify the location of the image region, a stained tumor cell (e.g., TC+) as the targeted type of biological structure, and “Path 4” as the identifier of the annotator that generated the annotation.

The annotation-processing system can determine an annotation-location conflict for one or more annotations associated with a region or object of the image. In some instances, the annotation-location conflict is determined based on the region having two or more annotations from a single annotator. Continuing from the above example, the annotation-processing system can identify an annotation-location conflict for a particular region by determining that five annotations are associated with the particular image region and further determining that two of the five annotations were submitted by the annotator identified as “Path 4”.

The annotation-processing system can then resolve the annotation-location conflict for the region or object of the image. For each of the two or more annotations of the region that are associated with the same annotator, the annotation-processing system can determine a statistical value (e.g., mean, median) that represents distances from the annotation to other annotations within the corresponding cluster. The statistical values between the two or more annotations from the same annotator can be compared. An annotation having the lowest statistical value can be determined to be a part of the region, while the remaining annotations of the conflict can be removed from being the part of the region. Additionally or alternatively, the annotation-processing system can apply a clustering algorithm (e.g., a k-means algorithm) to group the annotations such that a first subset of annotations represent a first sub-region of the region and a second subset of annotations represent a second sub-region of the region of the image.

Continuing with the above example, the annotation-processing system can determine a first statistical value of 10 pixels for a first annotation generated by “Path 4,” in which the first statistical value corresponds to a mean of distances between the first annotation and other annotations that are present in the particular region. The annotation-processing system can also determine a second statistical value of 15 pixels for a second annotation generated by “Path 4,” in which the second statistical value corresponds to a mean of distances between the second annotation and the other annotations. The annotation-processing system can resolve the annotation-location conflict by discarding the second annotation that has a greater statistical value.

After a consensus location is determined for a set of annotations, the annotation-processing system can determine a ground-truth label for the consensus location of the image. In some instances, the ground-truth label is determined if all of the set of annotations indicate the same targeted type of biological structure (e.g., the tumor cell). However, there are instances in which there is no clear consensus between the set of annotations with respect to the targeted type of biological structure. In such cases, the annotation-processing system can resolve an “annotation-label” conflict by: (i) determining a weight associated with each annotation; and (ii) comparing the weights to determine a consensus label for the consensus location. A weight is determined based on performance and historical data associated with an annotator who generated the annotation. For example, an annotator for a first annotation can be a senior pathologist who has several years of experience. A weight for the first annotation can be assigned with a value that is relatively greater than another weight of a second annotation that is associated with a junior pathologist.

Continuing with the example, the consensus location includes four annotations, in which annotators “Path 1” and “Path 3” label the location as having a stained tumor cell, while the two other annotators “Path 2” and “Path 4” label the location as having an unstained tumor cell. A first sum of weights assigned to “Path 1” and “Path 3” can then be compared with a second sum of weights assigned to “Path 2” and “Path 4.” If it is determined that the first sum is greater than the second sum, the annotation-processing system can determine a consensus label as “a stained tumor cell” for the consensus location.

The annotation-processing system can then generate a set of ground-truth labels for the image, based at least in part on the consensus locations and corresponding consensus labels. The set of ground-truth labels of the image can then be used to perform supervised training of a machine-learning model. In some instances, the set of ground-truth labels of the image are used to validate the machine-learning model. Additionally or alternatively, the set of ground-truth labels of the image can be used for testing of the machine-learning model. By determining the consensus locations and labels, accurate and consistent performance of the machine-learning model can be achieved.

In some instances, the annotation-processing system optimizes determination of consensus labels based on various adjustable parameters. For example, the annotation-processing system can enable adjusting of weights, based on performance of the respective annotators across different images or FOVs of a single image. In addition to the adjustments to the weights, other types of customization can be applied by the users to determine the consensus locations and labels. For example, a distance threshold can be adjusted by the user to determine whether a set of annotations identify a similar location in the image. These customizations allow better representation of the data for which consensus is computed. In addition, annotations and any conflict between the annotations can be displayed on a graphical user interface, at which the user can adjust the weight values and distance thresholds.

Certain embodiments described herein improve training of machine-learning models that classify biological structures in digital pathology images. The annotation-processing system can improve consistency and accuracy in generating ground-truth labels, by facilitating resolution of various types of conflicts (e.g., annotation-location conflicts, annotation-label conflicts) among annotations across the image. In effect, the annotation-processing system can be enabled to mitigate errors caused by annotators (e.g., pathologists), such as a particular annotated clicking on the wrong location of the image when generating the annotation. Moreover, the use of adjustable weights for the annotators can fine tune the consistency and accuracy of how the ground-truth labels are generated for the images. Accordingly, embodiments herein reflect an improvement in functions of artificial-intelligence systems and digital-pathology image processing technology.

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

### I. Definitions

As used herein, when an action is “based on” something, this means the action is based at least in part on at least a part of the something.

As used herein, the terms “substantially,” “approximately,” and “about” are defined as being largely but not necessarily wholly what is specified (and include wholly what is specified) as understood by one of ordinary skill in the art. In any disclosed embodiment, the term “substantially,” “approximately,” or “about” may be substituted with “within [a percentage] of” what is specified, where the percentage includes 0.1, 1, 5, and 10 percent.

As used herein, the term “sample,” “biological sample,” “tissue,” or “tissue sample” refers to any sample including a biomolecule (such as a protein, a peptide, a nucleic acid, a lipid, a carbohydrate, or a combination thereof) that is obtained from any organism including viruses. Other examples of organisms include mammals (such as humans; veterinary animals like cats, dogs, horses, cattle, and swine; and laboratory animals like mice, rats and primates), insects, annelids, arachnids, marsupials, reptiles, amphibians, bacteria, and fungi. Biological samples include tissue samples (such as tissue sections and needle biopsies of tissue), cell samples (such as cytological smears such as Pap smears or blood smears or samples of cells obtained by microdissection), or cell fractions, fragments or organelles (such as obtained by lysing cells and separating their components by centrifugation or otherwise). Other examples of biological samples include blood, serum, urine, semen, fecal matter, cerebrospinal fluid, interstitial fluid, mucous, tears, sweat, pus, biopsied tissue (for example, obtained by a surgical biopsy or a needle biopsy), nipple aspirates, cerumen, milk, vaginal fluid, saliva, swabs (such as buccal swabs), or any material containing biomolecules that is derived from a first biological sample. In some embodiments, the term “biological sample” as used herein refers to a sample (such as a homogenized or liquefied sample) prepared from a tumor or a portion thereof obtained from a subject.

As used herein, the term “biological material,” “biological structure,” or “cell structure” refers to natural materials or structures that comprise a whole or a part of a living structure (e.g., a cell nucleus, a cell membrane, cytoplasm, a chromosome, DNA, a cell, a cluster of cells, or the like).

As used herein, a “digital pathology image” refers to a digital image of a stained sample.

As used herein, the term “cell detection” refers to detection of the pixel locations and characteristics of a cell or a cell structure (e.g., a cell nucleus, a cell membrane, cytoplasm, a chromosome, DNA, a cell, a cluster of cells, or the like).

As used herein, the term “region” or “object” refers to a group of pixels of an image including image data that is intended be assessed in an image analysis process. A region or object may depict tissue regions that are intended to be analyzed in the image analysis process (e.g., tumor cells or staining expressions).

As used herein, the term “field-of-view” or “FOV” refers to a portion of a whole slide image, or the whole slide. In some embodiments, the “FOV” refers to a region of a whole slide scan or an area of interest having (x,y) pixel dimensions (e.g., 1000 pixels by 1000 pixels). In some embodiments, the FOV includes the same pixel resolution and/or magnification level associated with a corresponding whole slide image. Additionally or alternatively, the FOV includes a different pixel resolution and/or magnification level associated with the corresponding whole slide image.

### II. Overview

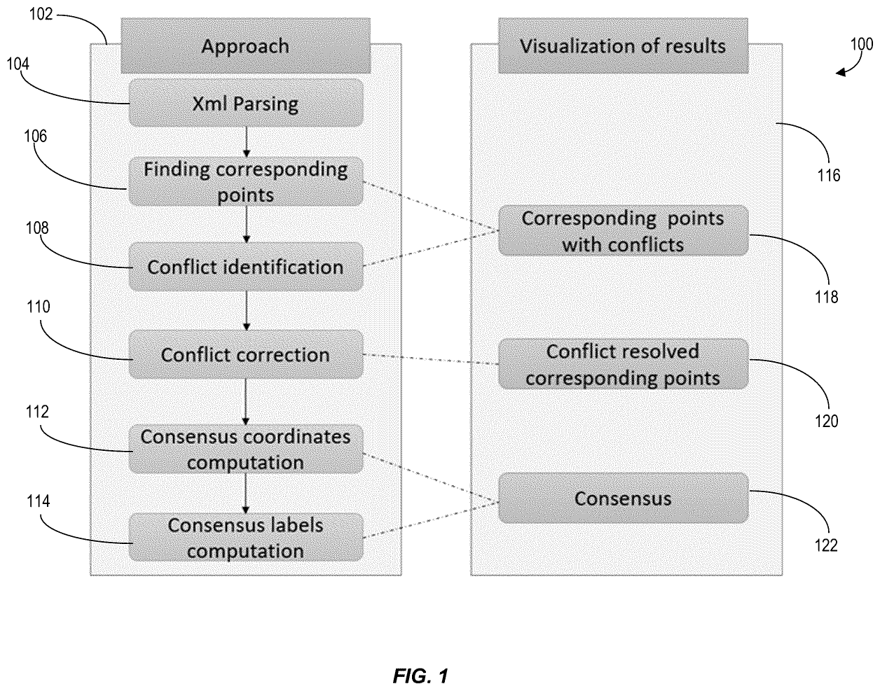

FIG. 1 shows an example schematic diagram 100 that illustrates a process for generating consensus labels for a slide image, according to some embodiments. The schematic diagram 100 includes: (i) an annotation-processing system 102 configured to generate consensus locations and labels for a given image; and (ii) a graphical-user interface 116 configured to display intermediate outputs of the annotation-processing system 102 to the user.

In block 104, the annotation-processing system 102 receives a set of annotations associated with an image. The image can be a digital pathology image depicting at least part of a biological sample (e.g., tissue) obtained from a subject. In some instances, an annotation tool is used by an annotator to provide the set of annotations for an entire tissue image or a selected region (e.g., a field-of-view (FOV)) of the image. The annotation tool can aggregate the set of annotations into a schema file (e.g., an XML document) and transmit the schema file to the annotation-processing system 102 for further processing. In some instances, the annotation tool is provided to each of multiple annotators involved in generating the ground-truth labels for the image, at which the respective schema files are transmitted to the annotation-processing system 102 for further processing. For example, the annotation-processing system 102 can receive 5 schema files, each of which including a set of annotations submitted by a corresponding annotator (e.g., a pathologist). In some embodiments, the annotation-processing system 102 receives and processes more than 10, 15, 20, 25, 30, 35, 40, 45, 50, or more than 50 schema files for a corresponding image.

The annotation tool can also provide available labels for classifying cells of the given image. The annotation can be added to a location of the image, in which the annotation can include a label that identifies a type of cell depicted in the image. In some instances, the label includes: (i) a TC+ label that identifies a tumor cell stained with a specific biomarker; (ii) a TC-label that identifies another tumor cell that is unstained; (iii) an IC label that identifies an immune cell; and (iv) an OTHER label that identifies cells other than tumor or immune cells.

In response to receiving the set of annotations, the annotation-processing system 102 can parse each annotation of the set to identify its corresponding annotation data. For example, an annotation can be parsed by the annotation-processing system 102 to identify an initial location for a region of the image and an initial label (e.g., a stained tumor cell) that classifies a biological structure depicted at the initial location of the image. In addition to the initial location and label, the annotation-processing system 102 can identify an identifier of the annotator who submitted the annotation, type of tissue depicted by the image, number of annotators who submitted the set of annotations for the image, and labels used for classifying cells of the image.

In block 106, the annotation-processing system 102 identifies one or more clusters of annotations that are associated with the image. For example, the location of the annotation can include a set of coordinates of the image for which the annotator has indicated as depicting a particular biological structure. The cluster can be defined as a set of annotations that are within a predetermined distance. In some instances, a threshold is used to determine the set of annotations, in which the threshold identifies a number of pixels between the annotations (e.g., 10 pixels). The threshold can be adjusted by an annotator, which may increase or decrease the number of annotations to be included in the cluster. By adjusting the threshold to increase or decrease the number of annotations, a size of the clusters in the image can be defined.

In block 108, the annotation-processing system 102 identifies annotation-location conflicts of the annotations. The annotation-processing system 102 can identify the annotation-location conflict by determining that two or more annotations associated with the same annotator (e.g., a pathologist) are associated within a particular cluster. Additionally or alternatively, the annotation-processing system 102 can identify the annotation-location conflict by detecting that a number of annotations in the particular cluster (e.g., 6 annotations) exceeds a total number of annotators who submitted the annotations for the image (e.g., 5 pathologists). In some instances, the graphical-user interface 116 displays the annotations having annotation-location conflicts (block 118).

In block 110, the annotation-processing system 102 resolves the annotation-location conflicts. For annotations that include location conflicts, the annotation-processing system 102 can determine, for each of the two or more annotations having the conflict (e.g., annotations generated by a particular annotator for the same object), a statistical value (e.g., mean, median) that represents distances from the annotation to other annotations within the corresponding region. The statistical values between the two or more annotations from the same annotator can be compared. An annotation having the lowest statistical value can be determined to be a part of the annotations of the region, while the remaining annotations of the conflict can be removed from being associated with the region. In some instances, the graphical-user interface 116 displays the annotations for which the annotation-location conflicts were resolved (block 120).

In block 112, the annotation-processing system 102 determines consensus locations for one or more regions of the image. Each region can include a set of annotations submitted by multiple annotators, and the consensus location for the cluster can be determined based on median coordinates between the locations of a set of annotations associated with the cluster. In some instances, a count of annotations for the region are compared to a predetermined confidence threshold. If the count falls below the confidence threshold, the set of annotations are discarded from the image. As a result, a ground-truth label for such region is not generated.

In block 114, the annotation-processing system 102 determines consensus labels for the image. The annotation-processing system 102 can use weighted values to determine consensus labels even when there is no majority of labels that are present for a given consensus location. For example, the consensus location may include four annotations, in which two annotations include labels that identify the location as depicting a tumor cell and the other two annotations include other labels identify the location as depicting a normal cell. Based on the weights applied to each of the annotations, the annotation-processing system 102 can resolve a “tie” between the annotations and determine a consensus label for the location. In some instances, the graphical-user interface 116 displays the consensus locations and labels for the image (block 122).

In some instances, the graphical-user interface 116 allows for adjustment of one or more parameters used by the annotation-processing system 102 in response to one or more of the visualizations 118, 120, and 122. For example, the graphical-user interface 116 can adjust a weighted value assigned to an annotator associated with a particular set of annotations. The weighted value can be adjusted by determining an accuracy metric for the annotator based on the validation of the image having the ground-truth labels. The accuracy metric can be determined based on a percentage of annotations (e.g., 75%, 85%) submitted by the annotator that correspond to ground truth. In some instances, the weighted value for the annotator is adjusted that is directly proportional to the accuracy metric determined for the annotator.

### III. Generation of Digital Pathology Images

Digital pathology involves the interpretation of digitized images in order to correctly diagnose subjects and guide therapeutic decision making. In digital pathology solutions, image-analysis workflows can be established to automatically detect or classify biological objects of interest e.g., positive, negative tumor cells, etc. An exemplary digital pathology solution workflow includes obtaining tissue slides, scanning preselected areas or the entirety of the tissue slides with a digital image scanner (e.g., a whole slide image (WSI) scanner) to obtain digital images, performing image analysis on the digital image using one or more image analysis algorithms, and potentially detecting, quantifying (e.g., counting or identify object-specific or cumulative areas of) each object of interest based on the image analysis (e.g., quantitative or semi-quantitative scoring such as positive, negative, medium, weak, etc.).

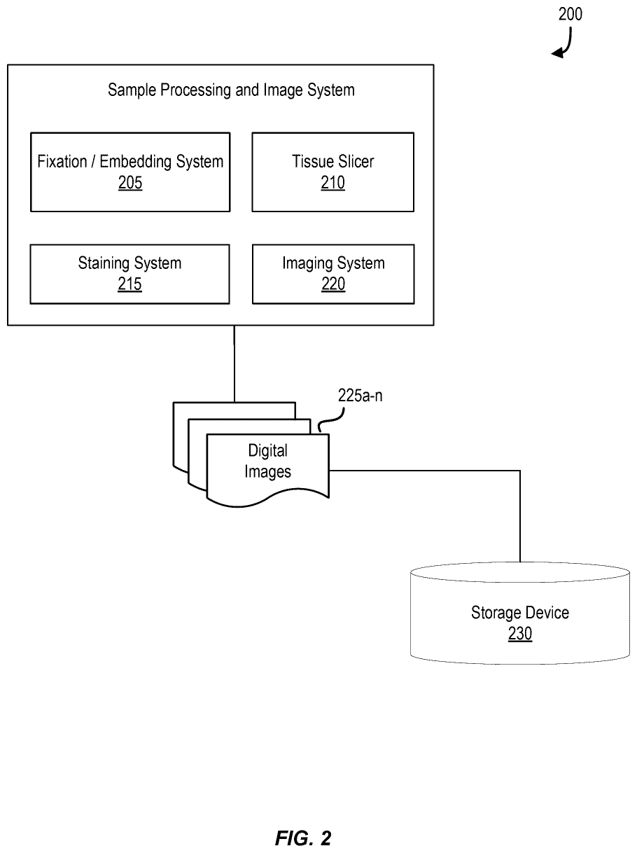

FIG. 2 shows an exemplary network 200 for generating digital pathology images. A fixation/embedding system 205 fixes and/or embeds a tissue sample (e.g., a sample including at least part of at least one tumor) using a fixation agent (e.g., a liquid fixing agent, such as a formaldehyde solution) and/or an embedding substance (e.g., a histological wax, such as a paraffin wax and/or one or more resins, such as styrene or polyethylene). Each sample may be fixed by exposing the sample to a fixating agent for a predefined period of time (e.g., at least 3 hours) and by then dehydrating the sample (e.g., via exposure to an ethanol solution and/or a clearing intermediate agent). The embedding substance can infiltrate the sample when it is in liquid state (e.g., when heated).

Sample fixation and/or embedding is used to preserve the sample and slow down sample degradation. In histology, fixation generally refers to an irreversible process of using chemicals to retain the chemical composition, preserve the natural sample structure, and maintain the cell structure from degradation. Fixation may also harden the cells or tissues for sectioning. Fixatives may enhance the preservation of samples and cells using cross-linking proteins. The fixatives may bind to and cross-link some proteins, and denature other proteins through dehydration, which may harden the tissue and inactivate enzymes that might otherwise degrade the sample. The fixatives may also kill bacteria.

The fixatives may be administered, for example, through perfusion and immersion of the prepared sample. Various fixatives may be used, including methanol, a Bouin fixative and/or a formaldehyde fixative, such as neutral buffered formalin (NBF) or paraffin-formalin (paraformaldehyde-PFA). In cases where a sample is a liquid sample (e.g., a blood sample), the sample may be smeared onto a slide and dried prior to fixation. While the fixing process may serve to preserve the structure of the samples and cells for the purpose of histological studies, the fixation may result in concealing of tissue antigens thereby decreasing antigen detection. Thus, the fixation is generally considered as a limiting factor for immunohistochemistry because formalin can cross-link antigens and mask epitopes. In some instances, an additional process is performed to reverse the effects of cross-linking, including treating the fixed sample with citraconic anhydride (a reversible protein cross-linking agent) and heating.

Embedding may include infiltrating a sample (e.g., a fixed tissue sample) with a suitable histological wax, such as paraffin wax. The histological wax may be insoluble in water or alcohol, but may be soluble in a paraffin solvent, such as xylene. Therefore, the water in the tissue may need to be replaced with xylene. To do so, the sample may be dehydrated first by gradually replacing water in the sample with alcohol, which can be achieved by passing the tissue through increasing concentrations of ethyl alcohol (e.g., from 0 to about 100%). After the water is replaced by alcohol, the alcohol may be replaced with xylene, which is miscible with alcohol. Because the histological wax may be soluble in xylene, the melted wax may fill the space that is filled with xylene and was filled with water before. The wax filled sample may be cooled down to form a hardened block that can be clamped into a microtome, vibratome, or compresstome for section cutting. In some cases, deviation from the above example procedure may result in an infiltration of paraffin wax that leads to inhibition of the penetration of antibody, chemical, or other fixatives.

A tissue slicer 210 may then be used for sectioning the fixed and/or embedded tissue sample (e.g., a sample of a tumor). Sectioning is the process of cutting thin slices (e.g., a thickness of, for example, 2-5 μm) of a sample from a tissue block for the purpose of mounting it on a microscope slide for examination. Sectioning may be performed using a microtome, vibratome, or compresstome. In some cases, tissue can be frozen rapidly in dry ice or Isopentane, and can then be cut in a refrigerated cabinet (e.g., a cryostat) with a cold knife. Other types of cooling agents can be used to freeze the tissues, such as liquid nitrogen. The sections for use with brightfield and fluorescence microscopy are generally on the order of 2-10 μm thick. In some cases, sections can be embedded in an epoxy or acrylic resin, which may enable thinner sections (e.g., <2 μm) to be cut. The sections may then be mounted on one or more glass slides. A coverslip may be placed on top to protect the sample section.

Because the tissue sections and the cells within them are virtually transparent, preparation of the slides typically further includes staining (e.g., automatically staining) the tissue sections in order to render relevant structures more visible. In some instances, the staining is performed manually. In some instances, the staining is performed semi-automatically or automatically using a staining system 215. The staining process includes exposing sections of tissue samples or of fixed liquid samples to one or more different stains (e.g., consecutively or concurrently) to express different characteristics of the tissue.

For example, staining may be used to mark particular types of cells and/or to flag particular types of nucleic acids and/or proteins to aid in the microscopic examination. The staining process generally involves adding a dye or stain to a sample to qualify or quantify the presence of a specific compound, a structure, a molecule, or a feature (e.g., a subcellular feature). For example, stains can help to identify or highlight specific biomarkers from a tissue section. In other example, stains can be used to identify or highlight biological tissues (e.g., muscle fibers or connective tissue), cell populations (e.g., different blood cells), or organelles within individual cells.

One exemplary type of tissue staining is histochemical staining, which uses one or more chemical dyes (e.g., acidic dyes, basic dyes, chromogens) to stain tissue structures. Histochemical staining may be used to indicate general aspects of tissue morphology and/or cell microanatomy (e.g., to distinguish cell nuclei from cytoplasm, to indicate lipid droplets, etc.). One example of a histochemical stain is H&E. Other examples of histochemical stains include trichrome stains (e.g., Masson's Trichrome), Periodic Acid-Schiff (PAS), silver stains, and iron stains. The molecular weight of a histochemical staining reagent (e.g., dye) is typically about 500 kilodaltons (kD) or less, although some histochemical staining reagents (e.g., Alcian Blue, phosphomolybdic acid (PMA)) may have molecular weights of up to two or three thousand kD. One case of a high-molecular-weight histochemical staining reagent is alpha-amylase (about 55 kD), which may be used to indicate glycogen.

Another type of tissue staining is IHC, also called “immunostaining”, which uses a primary antibody that binds specifically to the target antigen of interest (also called a biomarker). IHC may be direct or indirect. In direct IHC, the primary antibody is directly conjugated to a label (e.g., a chromophore or fluorophore). In indirect IHC, the primary antibody is first bound to the target antigen, and then a secondary antibody that is conjugated with a label (e.g., a chromophore or fluorophore) is bound to the primary antibody. The molecular weights of IHC reagents are much higher than those of histochemical staining reagents, as the antibodies have molecular weights of about 150 kD or more.

Various types of staining protocols may be used to perform the staining. For example, an exemplary IHC staining protocol includes using a hydrophobic barrier line around the sample (e.g., tissue section) to prevent leakage of reagents from the slide during incubation, treating the tissue section with reagents to block endogenous sources of nonspecific staining (e.g., enzymes, free aldehyde groups, immunoglobins, other irrelevant molecules that can mimic specific staining), incubating the sample with a permeabilization buffer to facilitate penetration of antibodies and other staining reagents into the tissue, incubating the tissue section with a primary antibody for a period of time (e.g., 1-24 hours) at a particular temperature (e.g., room temperature, 6-8° C.), rinsing the sample using wash buffer, incubating the sample (tissue section) with a secondary antibody for another period of time at another particular temperature (e.g., room temperature), rinsing the sample again using water buffer, incubating the rinsed sample with a chromogen (e.g., DAB: 3,3′-diaminobenzidine), and washing away the chromogen to stop the reaction. In some instances, counterstaining is subsequently used to identify an entire “landscape” of the sample and serve as a reference for the main color used for the detection of tissue targets. Examples of the counterstains may include hematoxylin (stains from blue to violet), Methylene blue (stains blue), toluidine blue (stains nuclei deep blue and polysaccharides pink to red), nuclear fast red (also called Kernechtrot dye, stains red), and methyl green (stains green); non-nuclear chromogenic stains, such as eosin (stains pink), etc. A person of ordinary skill in the art will recognize that other immunohistochemistry staining techniques can be implemented to perform staining.

In another example, an H&E staining protocol can be performed for the tissue section staining. The H&E staining protocol includes applying hematoxylin stain mixed with a metallic salt, or mordant to the sample. The sample can then be rinsed in a weak acid solution to remove excess staining (differentiation), followed by bluing in mildly alkaline water. After the application of hematoxylin, the sample can be counterstained with eosin. It will be appreciated that other H&E staining techniques can be implemented.

In some embodiments, various types of stains can be used to perform staining, depending on which features of interest is targeted. For example, DAB can be used for various tissue sections for the IHC staining, in which the DAB results a brown color depicting a feature of interest in the stained image. In another example, alkaline phosphatase (AP) can be used for skin tissue sections for the IHC staining, since DAB color may be masked by melanin pigments. With respect to primary staining techniques, the applicable stains may include, for example, basophilic and acidophilic stains, hematin and hematoxylin, silver nitrate, trichrome stains, and the like. Acidic dyes may react with cationic or basic components in tissues or cells, such as proteins and other components in the cytoplasm. Basic dyes may react with anionic or acidic components in tissues or cells, such as nucleic acids. As noted above, one example of a staining system is H&E. Eosin may be a negatively charged pink acidic dye, and hematoxylin may be a purple or blue basic dye that includes hematein and aluminum ions. Other examples of stains may include periodic acid-Schiff reaction (PAS) stains, Masson's trichrome, Alcian blue, van Gieson, Reticulin stain, and the like. In some embodiments, different types of stains may be used in combination.

The sections may then be mounted on corresponding slides, which an imaging system 220 can then scan or image to generate raw digital-pathology images 225a-n. A microscope (e.g., an electron or optical microscope) can be used to magnify the stained sample. For example, optical microscopes may have a resolution less than 1 μm, such as about a few hundred nanometers. To observe finer details in nanometer or sub-nanometer ranges, electron microscopes may be used. An imaging device (combined with the microscope or separate from the microscope) images the magnified biological sample to obtain the image data, such as a multi-channel image (e.g., a multi-channel fluorescent) with several (such as between ten to sixteen, for example) channels. The imaging device may include, without limitation, a camera (e.g., an analog camera, a digital camera, etc.), optics (e.g., one or more lenses, sensor focus lens groups, microscope objectives, etc.), imaging sensors (e.g., a charge-coupled device (CCD), a complimentary metal-oxide semiconductor (CMOS) image sensor, or the like), photographic film, or the like. In digital embodiments, the imaging device can include a plurality of lenses that cooperate to prove on-the-fly focusing. An image sensor, for example, a CCD sensor can capture a digital image of the biological sample. In some embodiments, the imaging device is a brightfield imaging system, a multispectral imaging (MSI) system or a fluorescent microscopy system. The imaging device may utilize nonvisible electromagnetic radiation (UV light, for example) or other imaging techniques to capture the image. For example, the imaging device may comprise a microscope and a camera arranged to capture images magnified by the microscope. The image data received by the analysis system may be identical to and/or derived from raw image data captured by the imaging device.

The images of the stained sections may then be stored in a storage device 225 such as a server. The images may be stored locally, remotely, and/or in a cloud server. Each image may be stored in association with an identifier of a subject and a date (e.g., a date when a sample was collected and/or a date when the image was captured). An image may further be transmitted to another system (e.g., a system associated with a pathologist, an automated or semi-automated image analysis system, or a machine learning training and deployment system, as described in further detail herein).

It will be appreciated that modifications to processes described with respect to network 200 are contemplated. For example, if a sample is a liquid sample, embedding and/or sectioning may be omitted from the process.

### IV. Exemplary System for Digital Pathology Image Transformation

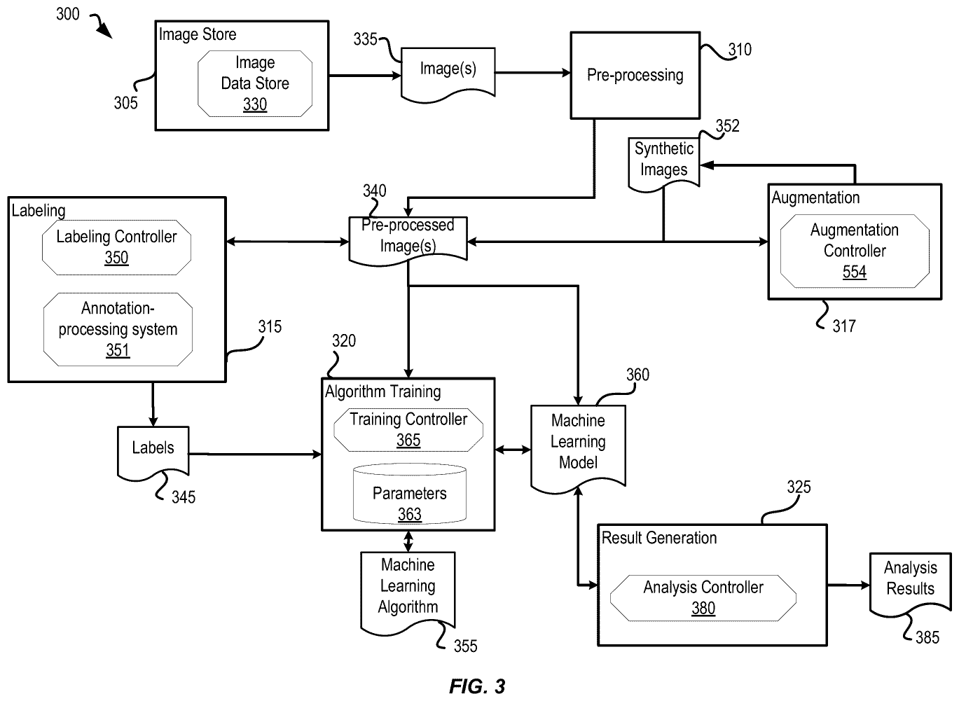

FIG. 3 shows a block diagram that illustrates a computing environment 300 for processing digital pathology images using a machine learning model. As further described herein, processing a digital pathology image can include using the digital pathology image to train a machine learning algorithm and/or transforming part or all of the digital pathology image into one or more results using a trained (or partly trained) version of the machine learning algorithm (i.e., a machine learning model).

As shown in FIG. 3, computing environment 300 includes several stages: an image store stage 305, a pre-processing stage 310, a labeling stage 315, a data augmentation stage 317, a training stage 320, and a result generation stage 325.

The image store stage 305 includes one or more image data stores 330 (e.g., storage device 230 described with respect to FIG. 2) that are accessed (e.g., by pre-processing stage 310) to provide a set of digital images 335 of preselected areas from or the entirety of the biological sample slides (e.g., tissue slides). Each digital image 335 stored in each image data store 330 and accessed at image store stage 310 may include a digital pathology image generated in accordance with part or all of processes described with respect to network 200 depicted in FIG. 2. In some embodiments, each digital image 335 includes image data from one or more scanned slides. Each of the digital images 335 may correspond to image data from a single specimen and/or a single day on which the underlying image data corresponding to the image was collected.

The image data may include an image, as well as any information related to color channels or color wavelength channels, as well as details regarding the imaging platform on which the image was generated. For instance, a tissue section may need to be stained by means of application of a staining assay containing one or more different biomarkers associated with chromogenic stains for brightfield imaging or fluorophores for fluorescence imaging. Staining assays can use chromogenic stains for brightfield imaging, organic fluorophores, quantum dots, or organic fluorophores together with quantum dots for fluorescence imaging, or any other combination of stains, biomarkers, and viewing or imaging devices. Example biomarkers include biomarkers for estrogen receptors (ER), human epidermal growth factor receptors 2 (HER2), human Ki-67 protein, progesterone receptors (PR), programmed cell death protein 1 (PD1), and the like, where the tissue section is detectably labeled with binders (e.g., antibodies) for each of ER, HER2, Ki-67, PR, PD1, etc. In some embodiments, digital image and data analysis operations such as classifying, scoring, cox modeling, and risk stratification are dependent upon the type of biomarker being used as well as the field-of-view (FOV) selection and annotations. Moreover, a typical tissue section is processed in an automated staining/assay platform that applies a staining assay to the tissue section, resulting in a stained sample. There are a variety of commercial products on the market suitable for use as the staining/assay platform, one example being the VENTANA® SYMPHONY® product of the assignee Ventana Medical Systems, Inc. Stained tissue sections may be supplied to an imaging system, for example on a microscope or a whole-slide scanner having a microscope and/or imaging components, one example being the VENTANA® iScan Coreo®/VENTANA® DP200 product of the assignee Ventana Medical Systems, Inc. Multiplex tissue slides may be scanned on an equivalent multiplexed slide scanner system. Additional information provided by the imaging system may include any information related to the staining platform, including a concentration of chemicals used in staining, a reaction times for chemicals applied to the tissue in staining, and/or pre-analytic conditions of the tissue, such as a tissue age, a fixation method, a duration, how the section was embedded, cut, etc.

At the pre-processing stage 310, each of one, more, or all of the set of digital images 335 are pre-processed using one or more techniques to generate a corresponding pre-processed image 340. The pre-processing may comprise cropping the images. In some instances, the pre-processing may further comprise standardization or rescaling (e.g., normalization) to put all features on a same scale (e.g., a same size scale or a same color scale or color saturation scale). In certain instances, the images are resized with a minimum size (width or height) of predetermined pixels (e.g., 2500 pixels) or with a maximum size (width or height) of predetermined pixels (e.g., 3000 pixels) and optionally kept with the original aspect ratio. The pre-processing may further comprise removing noise. For example, the images may be smoothed to remove unwanted noise such as by applying a Gaussian function or Gaussian blur.

The pre-processed images 340 may include one or more training images, validation images, test images, and unlabeled images. It should be appreciated that the pre-processed images 340 corresponding to the training, validation and unlabeled groups need not be accessed at a same time. For example, an initial set of training and validation pre-processed images 340 may first be accessed and used to train a machine learning algorithm 355, and unlabeled input images may be subsequently accessed or received (e.g., at a single or multiple subsequent times) and used by a trained machine learning model 360 to provide desired output (e.g., cell classification).

In some instances, the machine learning algorithms 355 are trained using supervised training, and some or all of the pre-processed images 340 are partly or fully labeled manually, semi-automatically, or automatically at labeling stage 315 with labels 345 that identify a “correct” interpretation (i.e., the “ground-truth”) of various biological material and structures within the pre-processed images 340. For example, the label 345 may identify a feature of interest (for example) a classification of a cell, a binary indication as to whether a given cell is a particular type of cell, a binary indication as to whether the pre-processed image 340 (or a particular region with the pre-processed image 340) includes a particular type of depiction (e.g., necrosis or an artifact), a categorical characterization of a slide-level or region-specific depiction (e.g., that identifies a specific type of cell), a number (e.g., that identifies a quantity of a particular type of cells within a region, a quantity of depicted artifacts, or a quantity of necrosis regions), presence or absence of one or more biomarkers, etc. In some instances, a label 345 includes a location. For example, a label 345 may identify a point location of a nucleus of a cell of a particular type or a point location of a cell of a particular type (e.g., raw dot labels). As another example, a label 345 may include a border or boundary, such as a border of a depicted tumor, blood vessel, necrotic region, etc. As another example, a label 345 may include one or more biomarkers identified based on biomarker patterns observed using one or more stains. For example, a tissue slide stained for a biomarker, e.g., programmed cell death protein 1 (“PD1”), may be observed and/or processed in order to label cells as either positive cells or negative cells in view of expression levels and patterns of PD1 in the tissue. Depending on a feature of interest, a given labeled pre-processed image 340 may be associated with a single label 345 or multiple labels 345. In the latter case, each label 345 may be associated with (for example) an indication as to which position or portion within the pre-processed image 345 the label corresponds.

A label 345 assigned at labeling stage 315 may be identified based on input from a human user (e.g., pathologist or image scientist) and/or an algorithm (e.g., an annotation tool) configured to define a label 345. In some instances, labeling stage 315 can include transmitting and/or presenting part or all of one or more pre-processed images 340 to a computing device operated by the user. In some instances, labeling stage 315 includes availing an interface (e.g., using an API) to be presented by labeling controller 350 at the computing device operated by the user, where the interface includes an input component to accept input that identifies labels 345 for features of interest. For example, a user interface may be provided by the labeling controller 350 that enables selection of an image or region of an image (e.g., FOV) for labeling. A user operating the terminal may select an image or FOV using the user interface. Several image or FOV selection mechanisms may be provided, such as designating known or irregular shapes, or defining an anatomic region of interest (e.g., tumor region). In one example, the image or FOV is a whole-tumor region selected on an IHC slide stained with an H&E stain combination. The image or FOV selection may be performed by a user or by automated image-analysis algorithms, such as tumor region segmentation on an H&E tissue slide, etc. For example, a user may select that the image or FOV as the whole slide or the whole tumor, or the whole slide or whole tumor region may be automatically designated as the image or FOV using a segmentation algorithm. Thereafter, the user operating the terminal may select one or more labels 345 to be applied to the selected image or FOV such as point location on a cell, a positive marker for a biomarker expressed by a cell, a negative biomarker for a biomarker not expressed by a cell, a boundary around a cell, and the like.

In some instances, the interface may identify which and/or a degree to which particular label(s) 345 are being requested, which may be conveyed via (for example) text instructions and/or a visualization to the user. For example, a particular color, size and/or symbol may represent that a label 345 is being requested for a particular depiction (e.g., a particular cell or region or staining pattern) within the image relative to other depictions. If labels 345 corresponding to multiple depictions are to be requested, the interface may concurrently identify each of the depictions or may identify each depiction sequentially (such that provision of a label for one identified depiction triggers an identification of a next depiction for labeling). In some instances, each image is presented until the user has identified a specific number of labels 345 (e.g., of a particular type). For example, a given whole-slide image or a given patch of a whole-slide image may be presented until the user has identified the presence or absence of three different biomarkers, at which point the interface may present an image of a different whole-slide image or different patch (e.g., until a threshold number of images or patches are labeled). Thus, in some instances, the interface is configured to request and/or accept labels 345 for an incomplete subset of features of interest, and the user may determine which of potentially many depictions will be labeled.

In some instances, labeling stage 315 includes labeling controller 350 implementing an annotation algorithm in order to semi-automatically or automatically label various features of an image or a region of interest within the image. The labeling controller 350 annotates the image or FOV on a first slide in accordance with the input from the user or the annotation algorithm and maps the annotations across a remainder of the slides. Several methods for annotation and registration are possible, depending on the defined FOV. For example, a whole tumor region annotated on a H&E slide from among the plurality of serial slides may be selected automatically or by a user on an interface such as VIRTUOSO/VERSO™ or similar. Since the other tissue slides correspond to serial sections from the same tissue block, the labeling controller 350 executes an inter-marker registration operation to map and transfer the whole tumor annotations from the H&E slide to each of the remaining IHC slides in a series. Exemplary methods for inter-marker registration are described in further detail in commonly-assigned and international application WO2014140070A2, “Whole slide image registration and cross-image annotation devices, systems and methods”, filed Mar. 12, 2014, which is hereby incorporated by reference in its entirety for all purposes. In some embodiments, any other method for image registration and generating whole-tumor annotations may be used. For example, a qualified reader such as a pathologist may annotate a whole-tumor region on any other IHC slide, and execute the labeling controller 350 to map the whole tumor annotations on the other digitized slides. For example, a pathologist (or automatic detection algorithm) may annotate a whole-tumor region on an H&E slide triggering an analysis of all adjacent serial sectioned IHC slides to determine whole-slide tumor scores for the annotated regions on all slides.

In some instances, labeling stage 315 further includes an annotation-processing system 351 implementing an annotation algorithm in order to identify annotation-location and annotation-label conflicts within a set of annotations associated with an image (or an FOV of the image). The annotation-processing system 351 can determine a consensus location for a set of annotations that are positioned in different locations within a region of a training image. In some instances, the annotation-processing system 351 determines that an annotation-location conflict exists for a region in the training image, by determining that two or more annotations from the same annotator are present in the region. The annotation-processing system 351 can resolve the such location conflict by keeping an annotation that has the closest distance to other annotations in the region while discarding other annotations from the same annotators. At the determined consensus location, a consensus label can be determined for the set of annotations that identify different targeted types of biological structures. The consensus labels across different locations can be used to generate ground-truth labels for the image. The ground-truth labels can be used to train, validate, and/or test a machine-learning model configured to predict different types of biological structures in digital pathology images.

At augmentation stage 317, training sets of images (original images) that are labeled or unlabeled from the pre-processed images 340 are augmented with synthetic images 352 generated using augmentation control 354 executing one or more augmentation algorithms. Augmentation techniques are used to artificially increase the amount and/or type of training data by adding slightly modified synthetic copies of already existing training data or newly created synthetic data from existing training data. As described herein, inter-scanner and inter-laboratory differences may cause intensity and color variability within the digital images. Further, poor scanning may lead to gradient changes and blur effects, assay staining may create stain artifacts such as background wash, and different tissue/patient samples may have variances in cell size. These variations and perturbations can negatively affect the quality and reliability of deep learning and artificial intelligence networks. The augmentation techniques implemented in augmentation stage 317 act as a regularizer for these variations and perturbations and help reduce overfitting when training a machine learning model. It should be understood that the augmentation techniques described herein can be used as a regularizer for any number and type of variations and perturbations and is not limited to the various specific examples discussed herein.

At training stage 320, labels 345 and corresponding pre-processed images 340 can be used by the training controller 365 to train machine learning algorithm(s) 355 in accordance with the various workflows described herein. For example, to train an algorithm 355, the pre-processed images 340 may be split into a subset of images 340a for training (e.g., 90%) and a subset of images 340b for validation (e.g., 10%). The splitting may be performed randomly (e.g., a 90/10% or 70/30%) or the splitting may be performed in accordance with a more complex validation technique such as K-Fold Cross-Validation, Leave-one-out Cross-Validation, Leave-one-group-out Cross-Validation, Nested Cross-Validation, or the like to minimize sampling bias and overfitting. The splitting may also be performed based on the inclusion of augmented or synthetic images 352 within the pre-processed images 340. For example, it may be beneficial to limit the number or ratio of synthetic images 352 included within the subset of images 340a for training. In some instances, the ratio of original images 335 to synthetic images 352 is maintained at 1:1, 1:2, 2:1, 1:3, 3:1, 1:4, or 4:1.

In some instances, the machine learning algorithm 355 includes a CNN, a modified CNN with encoding layers substituted by a residual neural network (“Resnet”), or a modified CNN with encoding and decoding layers substituted by a Resnet. In other instances, the machine learning algorithm 355 can be any suitable machine learning algorithm configured to localize, classify, and or analyze pre-processed images 340, such as a two-dimensional CNN (“2DCNN”), a Mask R-CNN, a U-Net, Feature Pyramid Network (FPN), a dynamic time warping (“DTW”) technique, a hidden Markov model (“HMM”), pure attention-based model, etc., or combinations of one or more of such techniques—e.g., vision transformer, CNN-HMM or MCNN (Multi-Scale Convolutional Neural Network). The computing environment 300 may employ the same type of machine learning algorithm or different types of machine learning algorithms trained to detect and classify different cells. For example, computing environment 300 can include a first machine learning algorithm (e.g., a U-Net) for detecting and classifying PD1. The computing environment 500 can also include a second machine learning algorithm (e.g., a 2DCNN) for detecting and classifying Cluster of Differentiation 68 (“CD68”). The computing environment 300 can also include a third machine learning algorithm (e.g., a U-Net) for combinational detecting and classifying PD1 and CD68. The computing environment 300 can also include a fourth machine learning algorithm (e.g., a HMM) for diagnosis of disease for treatment or a prognosis for a subject such as a patient. Still other types of machine learning algorithms may be implemented in other examples according to this disclosure.

The training process for the machine learning algorithm 355 includes selecting hyperparameters for the machine learning algorithm 355 from the parameter data store 363, inputting the subset of images 340a (e.g., labels 345 and corresponding pre-processed images 340) into the machine learning algorithm 355, and performing iterative operations to learn a set of parameters (e.g., one or more coefficients and/or weights) for the machine learning algorithms 355. The hyperparameters are settings that can be tuned or optimized to control the behavior of the machine learning algorithm 355. Most algorithms explicitly define hyperparameters that control different aspects of the algorithms such as memory or cost of execution. However, additional hyperparameters may be defined to adapt an algorithm to a specific scenario. For example, the hyperparameters may include the number of hidden units of an algorithm, the learning rate of an algorithm (e.g., 1e-4), the convolution kernel width, or the number of kernels for an algorithm. In some instances, the number of model parameters are reduced per convolutional and deconvolutional layer and/or the number of kernels are reduced per convolutional and deconvolutional layer by one half as compared to typical CNNs.

The subset of images 340a may be input into the machine learning algorithm 355 as batches with a predetermined size. The batch size limits the number of images to be shown to the machine learning algorithm 355 before a parameter update can be performed. Alternatively, the subset of images 340a may be input into the machine learning algorithm 355 as a time series or sequentially. In either event, in the instance that augmented or synthetic images 352 are included within the pre-processed images 340a, the number of original images 335 versus the number of synthetic images 352 included within each batch or the manner in which original images 335 and the synthetic images 352 are fed into the algorithm (e.g., every other batch or image is an original batch of images or original image) can be defined as a hyperparameter.

Each parameter is a tunable variable, such that a value for the parameter is adjusted during training. For example, a cost function or objective function may be configured to optimize accurate classification of depicted representations, optimize characterization of a given type of feature (e.g., characterizing a shape, size, uniformity, etc.), optimize detection of a given type of feature, and/or optimize accurate localization of a given type of feature. Each iteration can involve learning a set of parameters for the machine learning algorithms 355 that minimizes or maximizes a cost function for the machine learning algorithms 355 so that the value of the cost function using the set of parameters is smaller or larger than the value of the cost function using another set of parameters in a previous iteration. The cost function can be constructed to measure the difference between the outputs predicted using the machine learning algorithms 355 and the labels 345 contained in the training data. For example, for a supervised learning-based model, the goal of the training is to learn a function “h( )” (also sometimes referred to as the hypothesis function) that maps the training input space X to the target value space Y, h: X→Y, such that h(x) is a good predictor for the corresponding value of y. Various different techniques may be used to learn this hypothesis function. In some techniques, as part of deriving the hypothesis function, the cost or loss function may be defined that measures the difference between the ground truth value for an input and the predicted value for that input. As part of training, techniques such as back propagation, random feedback, Direct Feedback Alignment (DFA), Indirect Feedback Alignment (IFA), Hebbian learning, and the like are used to minimize this cost or loss function.

The training iterations continue until a stopping condition is satisfied. The training-completion condition may be configured to be satisfied when (for example) a predefined number of training iterations have been completed, a statistic generated based on testing or validation exceeds a predetermined threshold (e.g., a classification accuracy threshold), a statistic generated based on confidence metrics (e.g., an average or median confidence metric or a percentage of confidence metrics that are above a particular value) exceeds a predefined confidence threshold, and/or a user device that had been engaged in training review closes a training application executed by the training controller 365. Once a set of model parameters are identified via the training, the machine learning algorithms 355 has been trained and the training controller 365 performs the additional processes of testing or validation using the subset of images 340b (testing or validation data set). The validation process may include iterative operations of inputting images from the subset of images 340b into the machine learning algorithm 355 using a validation technique such as K-Fold Cross-Validation, Leave-one-out Cross-Validation, Leave-one-group-out Cross-Validation, Nested Cross-Validation, or the like to tune the hyperparameters and ultimately find the optimal set of hyperparameters. Once the optimal set of hyperparameters are obtained, a reserved test set of images from the subset of images 340b are input the machine learning algorithm 355 to obtain output, and the output is evaluated versus ground truth using correlation techniques such as Bland-Altman method and the Spearman's rank correlation coefficients and calculating performance metrics such as the error, accuracy, precision, recall, receiver operating characteristic curve (ROC), etc. In some instances, new training iterations may be initiated in response to receiving a corresponding request from a user device or a triggering condition (e.g., initial model development, model update/adaptation, continuous learning, drift is determined within a trained machine learning model 360, and the like).

As should be understood, other training/validation mechanisms are contemplated and may be implemented within the computing environment 300. For example, the machine learning algorithm 355 may be trained and hyperparameters may be tuned on images from the subset of images 340a and the images from the subset of images 340b may only be used for testing and evaluating performance of the machine learning algorithm 355. Moreover, although the training mechanisms described herein focus on training a new machine learning algorithm 355. These training mechanisms can also be utilized for initial model development, model update/adaptation, and continuous learning of existing machine learning models 360 trained from other datasets, as described in detail herein. For example, in some instances, machine learning models 360 might have been preconditioned using images of other objects or biological structures or from sections from other subjects or studies (e.g., human trials or murine experiments). In those cases, the machine learning models 360 can be used for initial model development, model update/adaptation, and continuous learning using the pre-processed images 340.

The trained machine learning model 360 can then be used (at result generation stage 325) to process new pre-processed images 340 to generate predictions or inferences such as predict cell centers and/or location probabilities, classify cell types, generate cell masks (e.g., pixel-wise segmentation masks of the image), predict a diagnosis of disease or a prognosis for a subject such as a patient, or a combination thereof. In some instances, the masks identify a location of depicted cells associated with one or more biomarkers. For example, given a tissue stained for a single biomarker the trained machine learning model 360 may be configured to: (i) infer centers and/or locations of cells, (ii) classify cells based on features of a staining pattern associated with the biomarker, and (iii) output a cell detection mask for the positive cells and a cell detection mask for the negative cells. By way of a another example, given a tissue stained for two biomarkers the trained machine learning model 360 may be configured to: (i) infer centers and/or locations of cells, (ii) classify cells based on features of staining patterns associated with the two biomarkers, and (iii) output a cell detection mask for cells positive for the first biomarker, a cell detection mask for cells negative for the first biomarker, a cell detection mask for cells positive for the second biomarker, and a cell detection mask for cells negative for the second biomarker. By way of another example, given a tissue stained for a single biomarker the trained machine learning model 360 may be configured to: (i) infer centers and/or locations of cells, (ii) classify cells based on features of cells and a staining pattern associated with the biomarker, and (iii) output a cell detection mask for the positive cells and a cell detection mask for the negative cells code, and a mask cells classified as tissue cells.

In some instances, an analysis controller 380 generates analysis results 385 that are availed to an entity that requested processing of an underlying image. The analysis result(s) 385 may include the masks output from the trained machine learning models 360 overlaid on the new pre-processed images 340. Additionally, or alternatively, the analysis results 385 may include information calculated or determined from the output of the trained machine learning models such as whole-slide tumor scores. In exemplary embodiments, the automated analysis of tissue slides use the assignee VENTANA's FDA-cleared 510(k) approved algorithms. Alternatively, or in addition, any other automated algorithms may be used to analyze selected regions of images (e.g., masked images) and generate scores. In some embodiments, the analysis controller 380 may further respond to instructions of a pathologist, physician, investigator (e.g., associated with a clinical trial), subject, medical professional, etc. received from a computing device. In some instances, a communication from the computing device includes an identifier of each of a set of particular subjects, in correspondence with a request to perform an iteration of analysis for each subject represented in the set. The computing device can further perform analysis based on the output(s) of the machine learning model and/or the analysis controller 380 and/or provide a recommended diagnosis/treatment for the subject(s).

It will be appreciated that the computing environment 300 is exemplary, and the computing environment 300 with different stages and/or using different components are contemplated. For example, in some instances, a network may omit pre-processing stage 310, such that the images used to train an algorithm and/or an image processed by a model are raw images (e.g., from image data store). As another example, it will be appreciated that each of pre-processing stage 310 and training stage 320 can include a controller to perform one or more actions described herein. Similarly, while labeling stage 315 is depicted in association with labeling controller 350 and while result generation stage 325 is depicted in association with analysis controller 380, a controller associated with each stage may further or alternatively facilitate other actions described herein other than generation of labels and/or generation of analysis results. As yet another example, the depiction of computing environment 300 shown in FIG. 3 lacks a depicted representation of a device associated with a programmer (e.g., that selected an architecture for machine learning algorithm 355, defined how various interfaces would function, etc.), a device associated with a user providing initial labels or label review (e.g., at labeling stage 315), and a device associated with a user requesting model processing of a given image (which may be a same user or a different user as one who had provided initial labels or label reviews). Despite the lack of the depiction of these devices, computing environment 300 may involve the use one, more or all of the devices and may, in fact, involve the use of multiple devices associated with corresponding multiple users providing initial labels or label review and/or multiple devices associated with corresponding multiple users requesting model processing of various images.

### V. Determining Consensus Locations of Annotations

When annotations across different annotators are added into an image, various types of annotation conflicts may inevitably occur. For example, one or more annotation-location conflicts between annotations can be found in the image. The annotation-location conflict can be identified when: (i) an annotation identifies that a cell is situated in a particular location of the image but one or more other annotations identify that the same cell is situated in a different location of the image; (ii) an annotation identifies that there are multiple cells situated in a given location but one or more other annotations identify that there is a single cell situated in the same given location; or (iii) an annotation identifies that there is a cell situated in a location but one or more other annotations identify that there are no cells situated in the location. Thus, determining a consensus location between the annotations can ensure that the corresponding labels are pointing to the same location and remove annotations (e.g., duplicate annotations) that may not accurately identify cells in the image.

### A. Input Data

To receive and process the annotations to be associated with a digital-pathology image (or an FOV of the image), an annotation-processing system (e.g., the annotation-processing system 102 of FIG. 1, the annotation-processing system 351 of FIG. 3) parses one or more schema files (or other types of data structure) provided by a set of annotators. A schema file can include a set of annotations, in which each annotation identifies an initial location for a particular image region of the image and an initial label (e.g., a stained tumor cell) that classifies a biological structure depicted at the initial location of the image. The annotations can be added by an annotator using an annotation tool (e.g., dpath). A set of protocols can be defined for the annotators, such that the annotations can be generated based on the same configuration for the image. The instructions can include a preconfigured values for: (i) a magnification level; (ii) type of cells to annotation; (iii) definition for each label; (iv) additional indicators for ambiguous cases; (v) use of a particular color profile; (vi) seed placements of the annotations; and (iv) indicates for cell at the border of the image.

In addition to the above information, the annotation can be associated with a location within the image. In some instances, the annotation includes x and y coordinates that identifies its location relative to the image. Additional data can be added into the annotation based on inputs provided by the annotator. Annotations from the annotator can be exported as a schema file, such as an XML file. In some instances, a single schema file is generated for the entire image. Additionally or alternatively, a schema file can be generated for each FOV of the image.

An annotation-processing system can receive and parse the schema file to determine a corresponding image (or FOV of the image) for which the annotations should be added and associate each annotation to a corresponding location of the image. The image with the annotations can be processed to be part of a training dataset used for training a machine-learning model. In some instances, the image is processed to be part of a validation dataset used for validating the machine-learning model. Additionally or alternatively, the image can be processed to be part of a test dataset used for testing the machine-learning model.

### B. Identifying Annotation Clusters

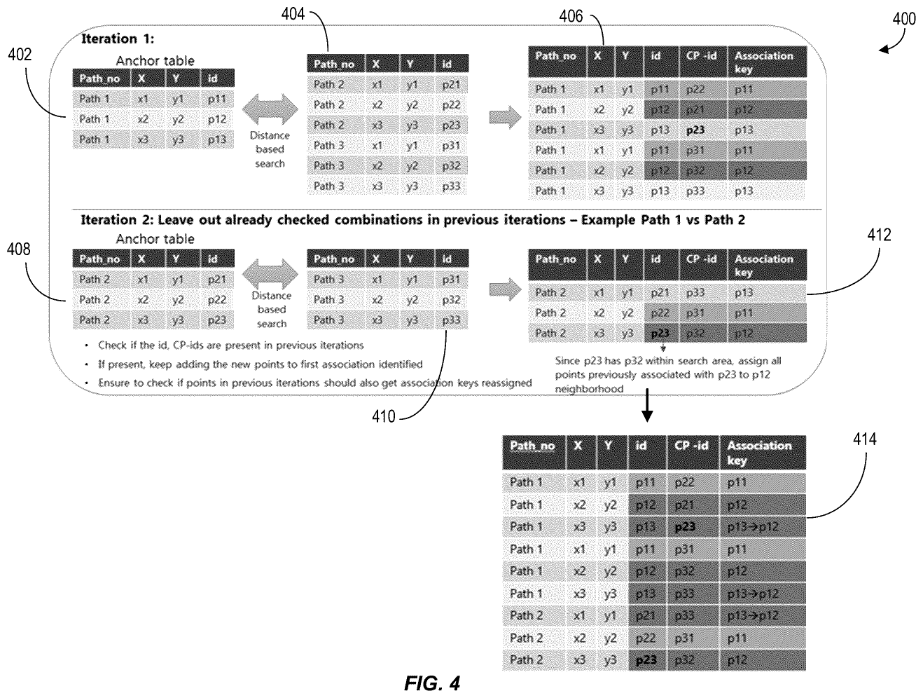

Once the annotations are processed, the annotation-processing system determines which annotations submitted by various annotators refer to the same location. FIG. 4 shows a schematic diagram that illustrates a process 400 for identifying clusters for a set of annotations for a slide image, according to some embodiments. The process 400 can iterate through annotations submitted by each annotator to identify the clusters, thereby associating annotations as corresponding to the same region.

As shown in FIG. 4, a plurality of annotations associated with the image can include a first set of annotations 402 associated with a first annotator “Path 1.” Each annotation of the first set 402 includes an identifier (e.g., “p11”) and a set of x and y coordinates that identify a location of the annotation within the image. The annotations of the first set of annotations 402 can be compared with annotations from a set of remaining annotations 404. The set of remaining annotations 404 can include a second set of annotations associated with a second annotator “Path 2” and a third set of annotations associated with a third annotator “Path 3”, in which annotation of the second and third sets includes a respective identifier (e.g., “p21”) and a respective set of x and y coordinates.

Based on the above information, the annotation-processing system can perform clustering of the plurality of annotations based on their respective x and y coordinates, thereby forming one or more annotation clusters. In some instances, one or more clusters are formed by performing a distance-based search between the plurality of annotations. The cluster can be defined as a set of annotations that are within a predetermined distance. In some instances, a threshold is used to determine the set of annotations, in which the threshold identifies a number of pixels between the annotations (e.g., 10 pixels). The threshold can be adjusted by an annotator, which may increase or decrease the number of annotations to be included in the cluster. By adjusting the threshold to increase or decrease the number of annotations, a size of the clusters in the image can be defined.

As shown in FIG. 4, a first set of clusters 406 includes a first cluster (noted in pink color) that includes “p11” annotation from the first set of annotations 404, as well as “p22” and “p31” annotations. The “p11” annotation can include the “p22” and “p31” identifiers as the closest points (“Cp-id”). The first cluster can then be identified by an associate key of “p11” for the first cluster of “p11”, “p22”, and “p31” annotations. Similarly, the first set of clusters 406 can include a second cluster (noted in teal color) that includes “p12”, “p21” and “p32” annotations, in which the second cluster can be identified by its association key “p12”.

Additional cluster combinations can be formed based on repeating the above process through other set of annotations (e.g., the second and third sets of the annotations). For example, the second set of annotations 408 associated with the second annotator “Path 2” can be compared with another set of remaining annotations 410. The other set of remaining annotations include the first set of annotations corresponding to “Path 1” and the third set of annotations corresponding to “Path 3.” The clustering can be performed to generate a second cluster of annotations 412, which can include an annotation “p23” of the second set of annotations 408 being associated with “p32” of the third set of annotations. In addition, “p22” and “p31” are associated with the same cluster based on the association key “p11.”. In some instances, the clustering is iterated through respective sets of annotations, until all possible combinations of the annotation clusters are formed.

The first cluster 406 and the second cluster 412 can then be merged to generate a merged cluster of annotations 414. The merged clusters can be generated by merging a cluster of the first set of clusters 406 with a corresponding cluster of the second set of clusters 412. For example, “p32” annotation can be identified as the closet annotations to “p12” annotation of the first set of annotations 404 and “p23” annotation of the second set of annotations 408. Based on this association, the “p23” annotation can be merged into the cluster having the association key “p12”. In another example, “p33” annotation can be identified as the closet annotation to “p21” annotation, which can also be identified as the closest annotation to “p12” annotation. As a result, the “p33” annotation can also be merged into the cluster having the association key “p12”.

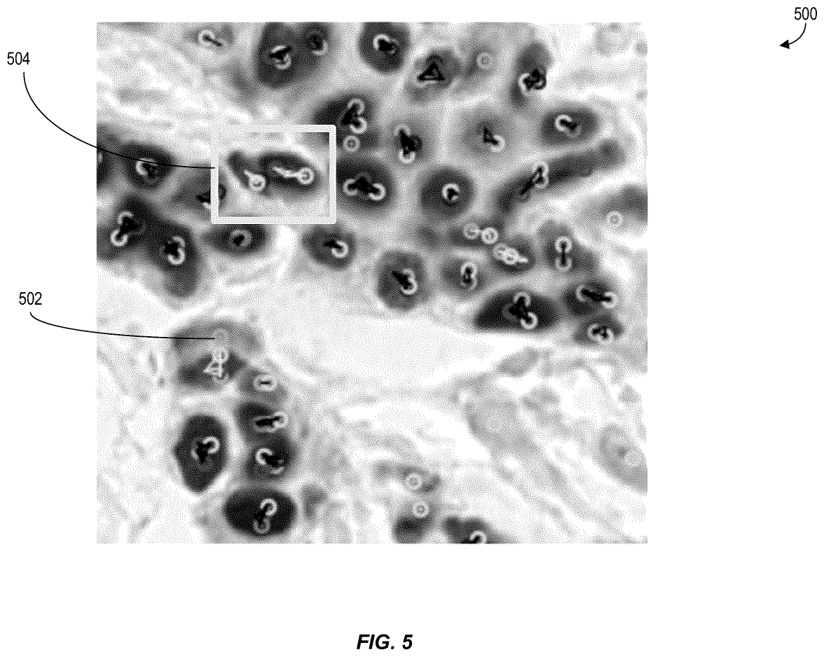

FIG. 5 shows an example image 500 that includes locations of the annotations, according to some embodiments. Each depicted cell in the image 500 is associated with one or more colored circles (e.g., pink, orange, blue, green, red), in which each circle represents an annotation 502. A color of the circle identifies the annotator that generated the annotation. For example, a red colored circle identifies a first pathologist who submitted the annotations for the image 500, and a blue circle identifies a second pathologist who submitted the annotations for the image 500. The annotations that are within the predetermined distance threshold (e.g., 10 pixels) can be associated as being a part of a cluster 504. The cluster 504 can represent a single cell and can be identified by yellow or black lines that connect the circles. In some instances, two or more clusters are merged into a single merged cluster 506.

### C. Removing Annotation Conflicts

When the clusters are generated for the annotations, annotation-location conflicts can occur when two or more annotations (representing multiple cells) from a particular annotator are identified as referring to the same cluster (representing a single cell) during the distance based search. The annotation-location conflicts can occur when two cells are located very closely to each other within a given image. In such cases, it becomes difficult to determine a cell to which a particular annotation refers. In another example, a pathologist could have erroneously indicated that two tumor cells exist for a single tumor cell, thereby causing an annotation-location conflict.

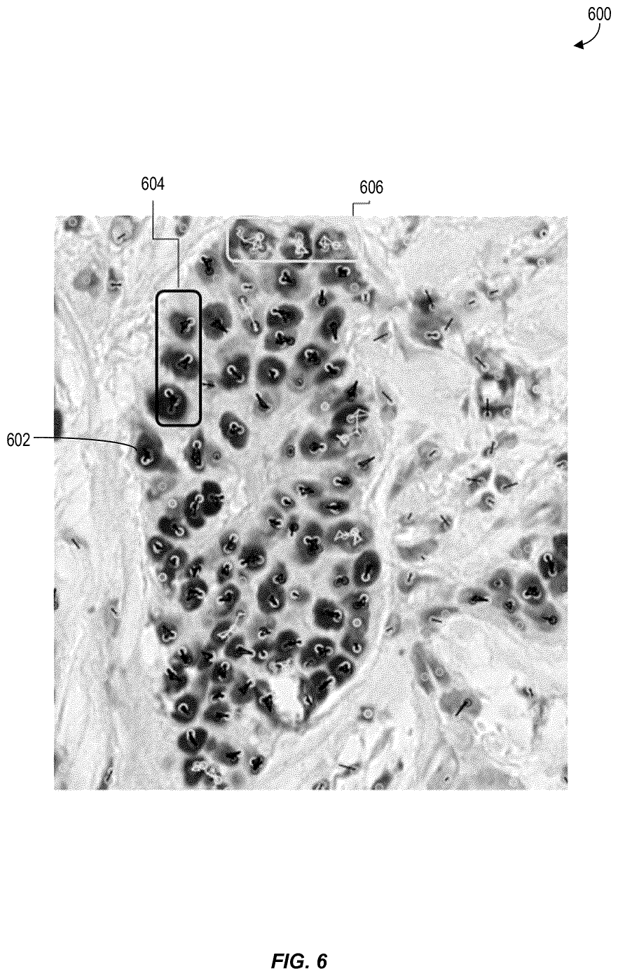

FIG. 6 shows an example set of annotations identified in a training slide image 600, according to some embodiments. Each depicted cell in the image 600 is associated with one or more colored circles (e.g., pink, orange, blue, green, red), in which each circle represents an annotation. A color of the circle identifies the annotator who submitted the annotation. The circles of the image 600 that are connected by black or yellow lines which represent a certain cluster. The cluster can represent or identify a single cell.

In a single cluster, two or more annotations (e.g., multiple cells) can be identified from the same annotator. For example, a cluster 602 can be identified by at least three orange circles, in which a corresponding annotator considers the image region as depicting three cells. Based on the three annotations from the same annotator, the annotation-processing system can determine that the cluster 602 includes at least one annotation-location conflict, because the cluster 602 is presumed to represent only a single cell but currently includes annotations indicating multiple cells. The annotation-location conflicts can be indicated by the annotation-processing system by tagging the cluster 602 (e.g., an association key of the cluster) as having a “conflict” and displaying such cluster on a graphical user interface.

In some instances, the annotation-processing system indicates the annotation-location conflicts by providing visual markers on the image 600. For example, a first set of clusters 604 can be indicated as having no annotation-location conflicts based on one or more “Black” lines that connect the annotations. By contrast, a second set of clusters 606 can be indicated as having one or more annotation-location conflicts based on one or more “Yellow” lines that connect the annotations.

Two types of annotation-location conflicts can be encountered during the process. The two types of annotation-location conflicts can include: (i) a first conflict type that involves a location having two or more annotations from a single annotator; and (ii) a second conflict type that involves a location having two or more annotations from each of two or more annotators.

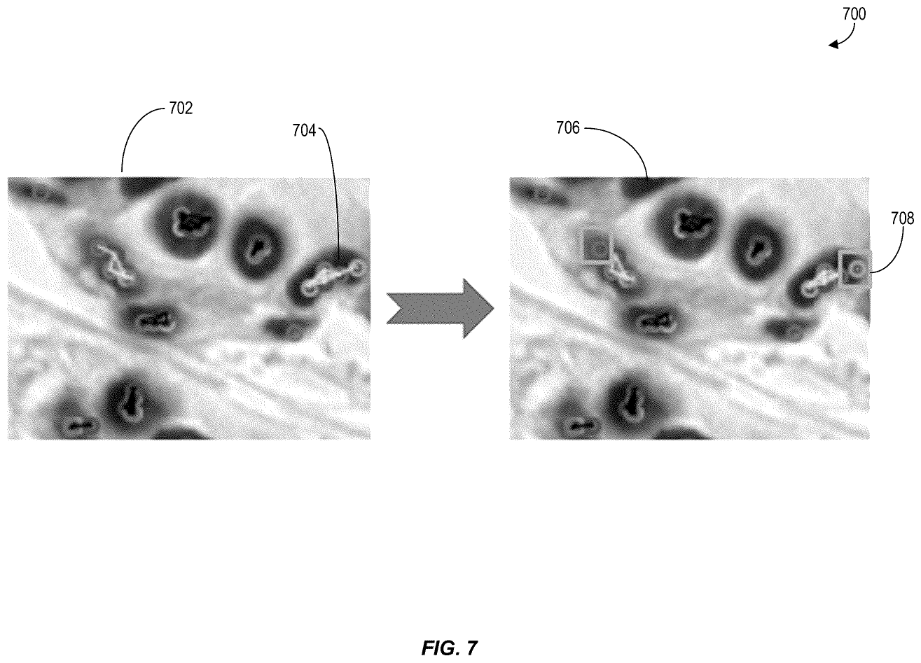

FIG. 7 shows example images that illustrate a process 700 in which annotation conflicts are resolved, according to some embodiments. The process 700 can include removing the annotation conflicts for the first conflict type. A pre-processed image 702 shows an example image that includes one or more annotation conflicts, including a cluster 704. For each of the two or more annotations from the same annotator, the annotation-processing system can determine a statistical value (e.g., mean, median) that represents distances from the annotation to other annotations within the corresponding cluster. The statistical values between the two or more annotations from the same annotator can be compared. An annotation having the lowest statistical value can be determined to be a part of the cluster, while the remaining annotations of the conflict can be removed from being part of the cluster. A post-processed image 706 shows another example image in which the one or more annotation conflicts are removed. As shown in the post-processed image 706, a yellow line connecting an orange circle 708 to the cluster 704 has been removed. In some instances, the orange circle 708 can form its own cluster and identify a different object or region within the image.

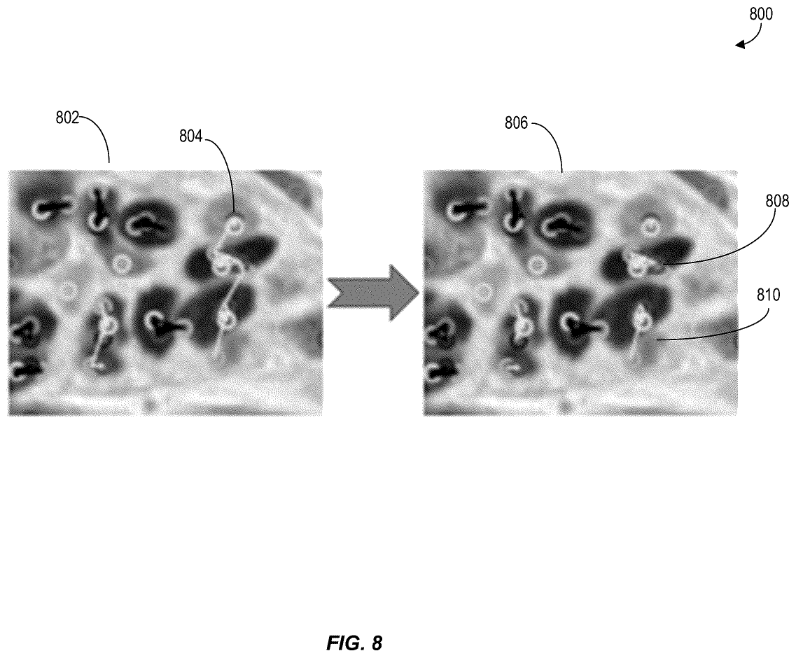

FIG. 8 shows another set of example images that illustrate a process 800 in which annotation conflicts are removed, according to some embodiments. A pre-processed image 802 shows an example image that includes one or more annotation conflicts, including merged cluster 804. The process 800 can include removing the annotation conflicts for the second conflict type. The annotation-processing system applies a clustering algorithm to a cluster that includes two or more annotations from each of two or more annotators, such that the cluster can be divided into sub-clusters. In some instances, the clustering algorithm includes a k-means algorithm that divides the cluster into a “k” number of sub-clusters. The “k” number of sub-clusters can correspond to a maximum number of annotations inputted by a particular annotator for a given cluster.

For each sub-cluster that includes two or more annotations from the same annotator, the annotation-processing system can determine, for each of the two or more annotations, a statistical value (e.g., mean, median) that represents distances from the annotation to other annotations within the corresponding cluster. The statistical values between the two or more annotations from the same annotator can be compared. An annotation having the lowest statistical value can be determined to be a part of the sub-cluster, while the remaining annotations can be removed from being the part of the sub-cluster. A post-processed image 806 shows another example image in which the one or more annotation conflicts are removed. Sub-clusters 808 and 810 shows two clusters that were divided from the merged cluster 804, in which the yellow line connecting the sub-clusters 808 and 810 is removed.

### D. Determining Consensus Locations

After the annotation conflicts are resolved, the annotation-processing system can determine a set of clusters that can remain in the image. A cluster of the set of clusters can include a number of annotations that exceed a confidence threshold. The confidence threshold can correspond to a minimum count of annotations that need to be present within a given cluster. For example, the confidence threshold can specify that at least three annotations need to be present for a cluster to remain in the image. A cluster that includes four annotations can be determined as exceeding the confidence threshold, and can be added into the set of clusters that can remain in the image. Conversely, a cluster that includes two annotations can be determined as not exceeding the confidence threshold. Such cluster is discarded from the image, and annotations of the cluster are also discarded from the image. As a result, the set of clusters having a sufficient number of annotations can then be further processed. In some instances, the confidence threshold is a percentage value (e.g., 0.5, 40%) that is compared to a statistical value that represents a fraction of annotations that are present in the cluster over a total number of annotators that generated the annotations for the image. The confidence threshold can be adjusted based on user input, which can result in an increase or decrease of ground-truth labels that would be present in the image.

After the clusters exceeding the confidence threshold are determined, a consensus location can be determined for each cluster identified in the image. Each cluster can include a set of annotations submitted by multiple annotators, and the consensus location for the cluster can be determined based on median coordinates between the locations of a set of annotations associated with the cluster. For example, x and y coordinates of each annotation of a given cluster can be identified. A median x-coordinate can be determined from the x-coordinates of set of annotations of the cluster. Similarly, a median y-coordinate can be determined from the y-coordinates of the set of annotations of the cluster. The median x-coordinate and median y-coordinate can be used to determine the consensus location of the cluster, such that a ground-truth label can be positioned at the consensus location of the image. Additionally or alternatively, other statistical values such as a mean value can be used in place of the median x-y coordinates.

In some instances, x and y coordinates of each annotation are assigned with a corresponding weight value, based on the annotator who submitted the annotation. For example, the x and y coordinates of an annotation submitted by a senior pathologist can be assigned with a weighted value that is greater than another weighted value assigned to the x and y coordinates of another annotation submitted by a junior pathologist. The consensus location can thus be determined based on the weighted x and y coordinates of the set of annotations within a given cluster. The consensus location for the cluster can be assigned with a ground-truth label that identifies a targeted type of biological structure (e.g., tumor cell) for a corresponding object or region within the image. And, the ground-truth label at the consensus location can be used to train a machine-learning model that predicts a type of biological structure in corresponding regions of other slide images.

### E. Methods for Identifying Annotation-Location Conflicts in an Image

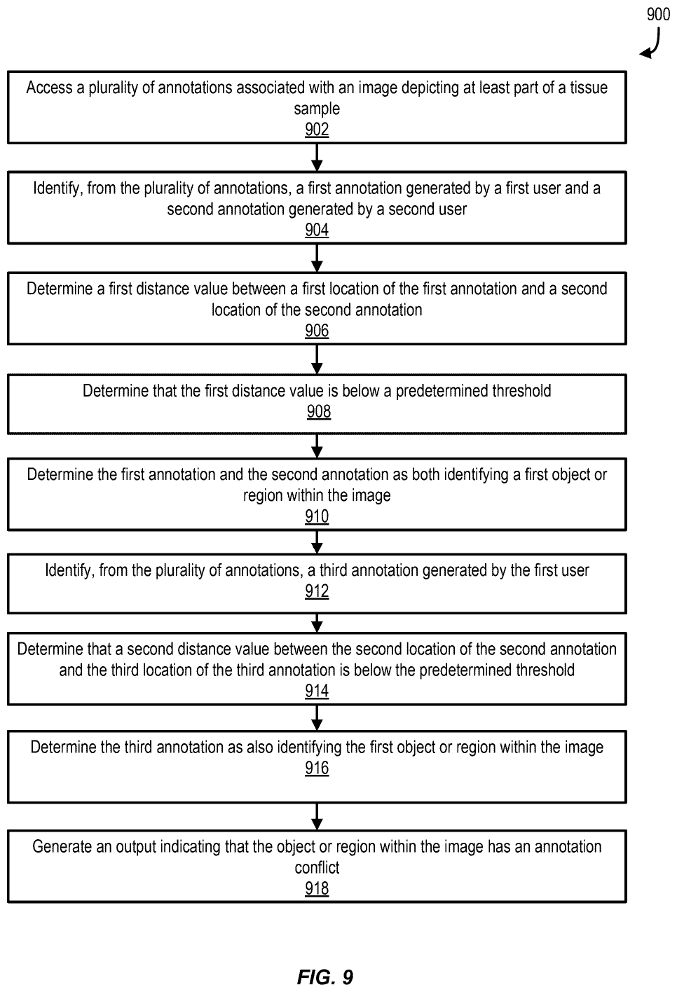

FIG. 9 illustrates a process 900 for identifying annotation-location conflicts in an image, in accordance with some embodiments. For illustrative purposes, the process 900 is described with reference to the components illustrated in FIG. 1 and/or FIG. 3, though other implementations are possible. For example, the program code for the annotation-processing system 102 of FIG. 1 and/or the annotation-processing system 351 of FIG. 3, which is stored in a non-transitory computer-readable medium, is executed by one or more processing devices to cause a server system to perform one or more operations described herein.

At step 902, an annotation-processing system accesses a plurality of annotations associated with an image depicting at least part of a biological sample. The image can be a digital pathology image depicting at least part of a biological sample (e.g., tissue) obtained from a subject. The plurality of annotations can be used to generate ground-truth labels for supervised training, validation, and/or testing of a machine-learning model. Each annotation of the plurality of annotations can be positioned within the image at a location that identifies an object or region within the image. In some instances, each annotation includes an identifier associated with an annotator (e.g., a pathologist) that generated the annotation.

At step 904, the annotation-processing system identifies, from the plurality of annotations, a first annotation generated by a first annotator and a second annotation generated by a second annotator. In some instances, the first annotation further includes a label (e.g., a stained tumor cell, an unstained tumor cell, a normal cell) that classifies a targeted type of biological structure depicted at its first location of the image. Similarly, the second annotation includes its respective label that classifies the same or different targeted type of biological structure depicted at its second location of the image.

At step 906, the annotation-processing system determines a first distance value between a first location of the first annotation and a second location of the second annotation.

At step 908, the annotation-processing system determines that the first distance value is below a predetermined threshold. The predetermined threshold can be used to determine whether the first and second annotations correspond to the same object or region within the image. In some instances, the predetermined threshold is adjusted to increase or decrease a number of annotations that collectively identify the same object or region of the image.

At step 910, the annotation-processing system determines the first annotation and the second annotation as both identifying a first object or region within the image, in response to determining that the first distance value is below the predetermined threshold.

At step 912, the annotation-processing system identifies, from the plurality of annotations, a third annotation generated by the first annotator, wherein the third annotation is positioned at a third location that is different from the first location.

At step 914, the annotation-processing system determines that a second distance value between the second location of the second annotation and the third location of the third annotation is below the predetermined threshold.

At step 916, the annotation-processing system determines the third annotation as also identifying the first object or region within the image, in response to determining that the second distance value is below the predetermined threshold.

At step 918, the annotation-processing system generates an output indicating that the object or region within the image has an annotation conflict, in response to determining the third annotation as identifying the first object or region within the image. Process 900 terminates thereafter.

### F. Methods for Removing Annotation-Location Conflicts in an Image

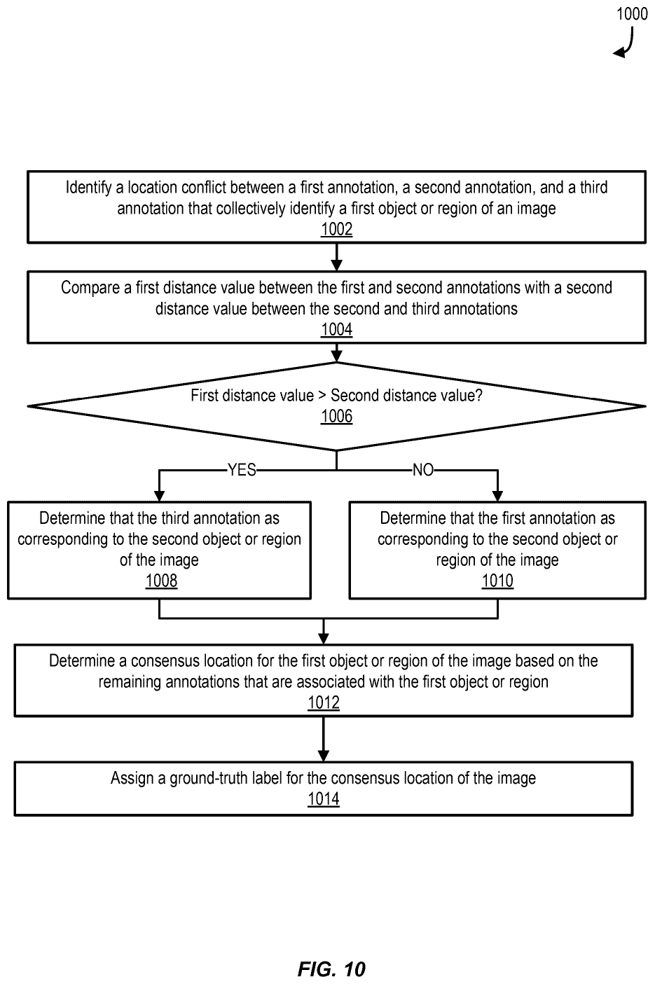

FIG. 10 illustrates a process 1000 for removing annotation-location conflicts and determining consensus labels in an image, in accordance with some embodiments. For illustrative purposes, the process 1000 is described with reference to the components illustrated in FIG. 1 and/or FIG. 3, though other implementations are possible. For example, the program code for the annotation-processing system 102 of FIG. 1 and/or the annotation-processing system 351 of FIG. 3, which is stored in a non-transitory computer-readable medium, is executed by one or more processing devices to cause a server system to perform one or more operations described herein.

At step 1002, the annotation-processing system identifies a location conflict between a first annotation, a second annotation, and a third annotation of an image. The training image can be a digital pathology image depicting at least part of a biological sample (e.g., tissue) obtained from a subject. The first, second, and third annotations can be used to generate ground-truth labels for supervised training, validation, and/or testing of a machine-learning model. The first and third annotations were generated by the first annotator, and the second annotation was generated by the second annotator. The first, second, and third annotations can be identified as identifying a first object or region within the image. The annotation conflict can be determined using the steps of the process 900 of FIG. 9.

At step 1004, the annotation-processing system compares a first distance value between the first and second annotations with a second distance value between the second and third annotations. The first distance value can correspond to a distance between a first location of a first annotation and a second location of a second annotation. The second distance value can correspond to a distance between the second location and a third location of a third annotation.

At step 1008, if the first distance value is greater than the second distance value (“yes” path from step 1006), the annotation-processing system can resolve the annotation-location conflict by determining that the third annotation as corresponding to a second object or region of the image (e.g., a different cluster). At step 1010, if the second distance value is greater than the first distance value (“no” path from step 1006), the annotation-processing system can resolve the annotation-location conflict by determining that the first annotation as corresponding to the second object or region of the image (e.g., a different cluster).

At step 1012, the annotation-processing system determines a consensus location for the first object or region of the image, based on the remaining annotations that are associated with the first object or region. The consensus location can be determined based on median coordinates between the locations of the remaining annotations associated with first object or region of the image. Additionally or alternatively, other statistical values such as a mean value can be used in place of the median x-y coordinates.

In some instances, the annotation-processing system resolves another type of annotation-location conflict that involve two or more annotations from each of two or more annotators. For example, the annotation-processing system identifies a fourth annotation generated by the second annotator. The fourth annotation is positioned at a fourth location of the image that is different from the second location of the second annotation. The annotation-processing system then determines a third distance value between the third location and the fourth location and further determines that the third distance value is below the predetermined threshold. In response to determining that the third distance value is below the predetermined threshold value, the annotation-processing system determines that the first annotation, the second annotation, the third annotation, and the fourth annotation identify the same object or region within the image. Since two or more annotations from each of first and second annotators were identified for the same region, the annotation-processing system can determine that a different type of annotation-location conflict has occurred.

To resolve the other annotation-location conflict, the annotation-processing system can apply a clustering algorithm to the first location, the second location, the third location, and the fourth location. The clustering algorithm can be applied to determine that: (i) the first annotation and the second annotation correspond to a first subregion of the first object or region; and (ii) the third annotation and the fourth annotation correspond to a second subregion of the first object or region. In some instances, the clustering algorithm is a k-means clustering algorithm.

At step 1014, the annotation-processing system assigns a ground-truth label for the consensus location of the image. The ground-truth label identifies a targeted type of biological structure (e.g., tumor cell) for the first object or region within the image. The ground-truth label at the consensus location can be used to train a machine-learning model that predicts a type of biological structure in corresponding regions of other slide images. The training of the machine-learning model using the ground-truth labels having consensus locations can correspond to the training process described in FIG. 3. For the different type of annotation-location conflict that resulted in the first and second subregions, the annotation-processing system can assign a respective ground-truth label for each of the first and second subregions. Process 1000 terminates thereafter.

### VI. Determining a Consensus Label for the Annotations

After a consensus location is determined for a set of annotations, the annotation-processing system can determine a ground-truth label for the consensus location of an image, in which the ground-truth label can be used for training, validation, and/or testing of a machine-learning model. In some instances, the ground-truth label is determined if all of the set of annotations indicate the same targeted type of biological structure (e.g., the tumor cell). Similarly, the ground-truth label can be determined based on a clear majority of the set of annotations identifying a particular targeted type of biological structure. However, there are instances in which there is no clear consensus between the set of annotations with respect to the targeted type of biological structure. For example, the consensus location can include four annotations, in which two annotators label the location as having a stained tumor cell, while the two other annotators label the location as having an unstained tumor cell.

In the event of such annotation-label conflict, the annotation-processing system can determine a consensus label for the object or region of the image. In particular, each annotation of the set of annotations can the assigned with a corresponding weight value. The weight value is determined based on performance and historical data associated with an annotator who generated the annotation. For example, an annotator for a first annotation can be a senior pathologist who has several years of experience. A weight for the first annotation can be assigned with a value that is relatively greater than another weight of a second annotation that is associated with a junior pathologist.

Then, each targeted type of biological structure can be represented by an aggregated weight derived from the weights assigned to the corresponding annotations. A ground-truth label can be generated to include a particular targeted type of biological structure, in response to determining that the particular targeted type of biological structure has the highest aggregated weight. As a result, consensus label can be determined for the region or object of the image, at which the ground-truth label can include the information from the consensus label. The determination of consensus labels can facilitate accurate training, validation, and testing of the machine learning models, even when some annotations at the same location provide conflicting information.

### A. Determining Whether the Set of Annotations can be Used to Determine a Consensus Label for a Region of the Image

The annotation-processing system can determine whether a set of annotations that correspond to a particular region or object of an image (e.g., the consensus location) can be used to generate a consensus label.

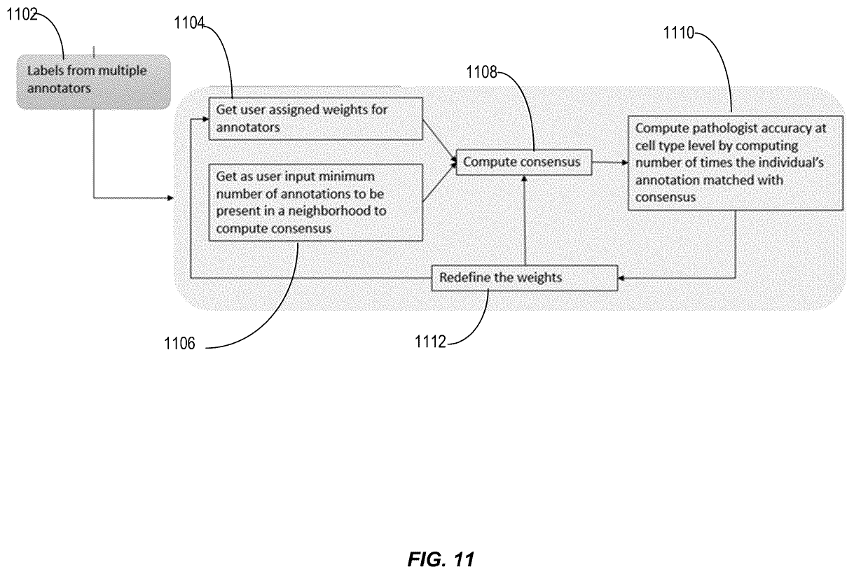

FIG. 11 illustrates a schematic diagram that describes a process 1100 for removing annotation-label conflicts and determining a consensus label for an image, according to some embodiments. At block 1102, the annotation-processing system receives a set of annotations that correspond to a region or object of an image. The image can be part of a training dataset used for training a machine-learning model. In some instances, the image is part of a validation dataset used for validating the machine-learning model. Additionally or alternatively, the image can be part of a test dataset used for testing the machine-learning model. The region or object can be identified based on a consensus location determined using the processes described in FIGS. 9 and 10.

At block 1104, the annotation-processing system can retrieve weights associated with the set of annotations. For each annotation of the set of annotations, a weight can be assigned to the annotation, in which the weight can be determined based on performance and historical data associated with an annotator who generated the annotation. For example, the weight can be determined based on a level of expertise of the annotator who generated the annotation. In some instances, each weight of the weights corresponds to a value between 0 and 1, and the sum of weights of all annotators can add up to 1.

In some instances, the annotation-processing system calculates a sum of the weights and compare the sum against a predetermined confidence threshold. The confidence threshold is a user-adjustable value that can specify a number of annotations needed to generate the consensus label. The comparison of the weights against the confidence threshold can facilitate a determination of whether the set of annotations include information that is sufficient for generating the consensus label.

As an illustrative example, two annotations corresponding to the region of the image can be determined as sufficient for generating the consensus label, based on a sum of corresponding weights of the two annotations exceeding the confidence threshold. In another example, four annotations corresponding to another region of the image can be determined as insufficient for generating the consensus label, based on a sum of their corresponding weights not exceeding the confidence threshold. In some instances, the annotation-processing system includes one or more other annotations that correspond to a location in proximity to the particular region or object, such that some annotations having higher weights can be also considered.

At block 1106, the annotation-processing system can determine whether the set of annotations are sufficient for generating the consensus label, based on comparing a count of the set of annotations for the particular region or object to a second confidence threshold. For example, the second confidence threshold can be three, in which the set of annotations can be considered as sufficient for generating the consensus label if their count is equal to or greater than three. If the count of the set of annotations does not exceed the second confidence threshold, the annotation-processing system can discard the set of annotations from the particular region or object, such that the set of annotations are no longer processed for generating the ground-truth label. In contrast, if the count of the set of annotation exceeds the second confidence threshold, the annotation-processing system can use the set of annotations for generating the consensus label. This process can be repeated for annotations from each of other regions or objects in the image. As a result, the sets of annotations across different regions or objects can then be used for generating consensus labels for the image.

### B. Resolving Label-Conflicts in the Set of Annotations

For the set of annotations that correspond to an object or region of the image, the annotation-processing system can remove any label-conflicts and generate a consensus label for the object or region. Referring back to FIG. 11, the annotation-processing system can identify a targeted type of biological structure based on weights assigned to the set of annotations (block 1108). For each targeted type of biological structure identified in the set of annotations, an aggregated weight can be determined based on a subset of annotations that include the targeted type of biological structure. For example, a first aggregated weight for a targeted stained tumor cell can be based on weights of three annotations of the set of annotations that identify a corresponding region of the image as depicting the tumor cell. In another example, a second aggregated weight for a targeted immune cell (e.g., lymphocytes) can be based on weights of two remaining annotations of the set of annotations that identify a corresponding region of the image as depicting the immune cell. In some instances, the aggregated weight corresponds to a sum of all the weights that are associated with the corresponding targeted type of biological structure. Additionally or alternatively, the aggregated weight can correspond to a mean or median of all the weights that are associated with the corresponding targeted type of biological structure.

The annotation-processing system can compare the aggregated weights to determine a targeted type of biological structure that has the highest weight. The targeted type of biological structure with the highest aggregated weight can be identified as the consensus label for the region or object of the image. As a result, a ground-truth label that includes the targeted type can then be generated for the image. Continuing from the above example, the second aggregated weight for the targeted immune cell can be determined as being greater than the first aggregated weight, even when the targeted stained tumor cell is associated with a greater number of annotations. In response to the determination, the annotation-processing system generates a ground-truth label for the corresponding region of the image, in which the ground-truth label includes the immune cell.

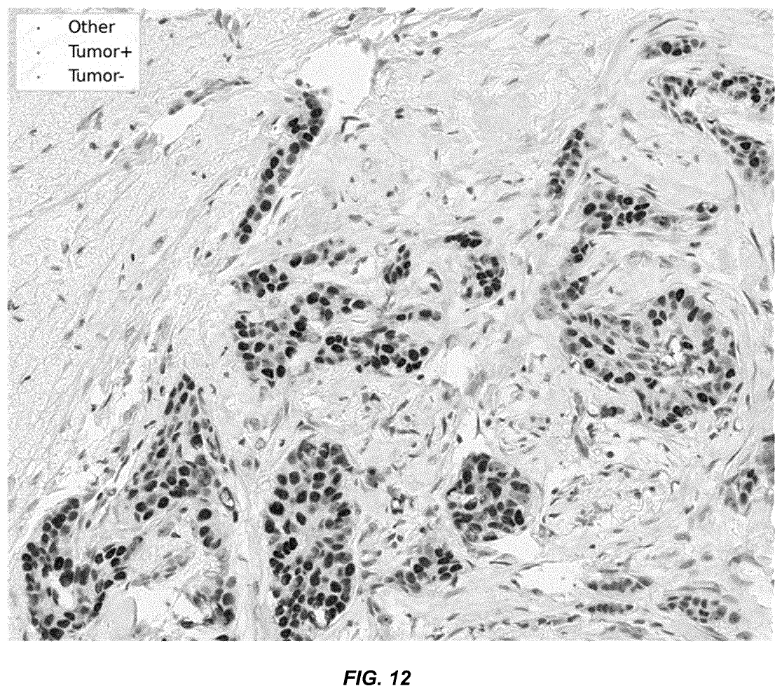

FIG. 12 illustrates an example image 1200 that includes consensus labels and locations, according to some embodiments. Each dot represents a consensus location that depicts a biological structure (e.g., tumor cell). A color of the dot represents a ground-truth label for the location. For example, a “blue” dot represents other types of cells (e.g., lymphocytes, fibroblasts), a “red” dot represents a stained tumor cell, and a “green” dot represents an unstained tumor cell.

In some instances, there are situations in which at least two aggregated weights are equal to each other for the corresponding region of the image. Referring back to FIG. 11, the annotation-processing system can determine a secondary weight for each annotation of the set of annotations (block 1110). The secondary weight can correspond to a value assigned based on an accuracy metric assigned to an annotator who generated the annotation. The accuracy metric can be determined based on a number of other annotations provided by the annotator for other regions of the images that match the respective consensus labels. The secondary weights can be used to normalize the aggregated weights, at which the targeted type of biological structure associated with the greater normalized weight can be identified as the consensus label for the corresponding region.

As an illustrative example, an object or region of the image includes two annotations, in which a first annotation indicates a stained tumor cell and a second annotation indicates an unstained tumor cell. The annotation-processing system determines that the two annotations have equal weights assigned to them, thereby identifying a label conflict between the annotations. In response to such determination, a secondary weight for the first annotation can be calculated based on a determination that 90% of the annotations generated by an annotator for other regions are concordant with the corresponding consensus labels. Then, a secondary weight for the second annotation can be calculated based on a determination that 80% of the annotations generated by another annotator for other regions are concordant with the corresponding consensus labels, in which the secondary weight of the second annotation is less than the secondary weight of the first annotation based on their respective accuracy metrics. Based on the comparison, the stained tumor cell indicated by the first annotation can be selected to generate the ground-truth label for the object or region of the image. Accordingly, by using the weights and the secondary weights, the annotation-processing system can resolve annotation-label conflicts in various regions of the image.

### C. Adjusting Weights Based on Annotator Performance

The consensus labels can be used to train a machine-learning model, but also can be used to reevaluate the annotators and adjust their corresponding weights. Referring to FIG. 11, the annotation-processing system can adjust a weight associated with an annotator by tracking its performance through different images (e.g., training images, validation images) or different FOVs within the same image (block 1112). For an annotator that generated one or more annotations in the image (or FOV in the image), the annotation-processing system can determine a number of annotations that match the respective consensus labels in a given image. The number of annotations can be compared with a total number of annotations generated by the annotator for the image. Based on the comparison, the annotation-processing system can adjust a weight that is associated with the annotator. The weight-adjustment process can continue across other images to fine tune the weight of the annotator. The above process can be repeated across other annotators who generated the annotations for the image. Additionally or alternatively, the annotation-processing system can adjust the weight of the annotator based on the numbers of annotations that match the respective consensus labels for each targeted type of biological structure defined for the image.

In some instances, the weight for the annotator is adjusted based on its performance relative to performances of other annotators for the image. For example, a first annotator can be determined to have 85% of annotations that match the respective consensus labels of the image. A second annotator can be determined to have 89% of annotations that match the respective consensus labels of the image. The performance of the first annotator and the second annotator can be compared and a higher weight can be assigned to the second annotator than that of the first annotator based on the comparison (e.g., weights assigned commensurate to the percentage of annotations that match the respective consensus labels). If there are three or more annotators that generated the annotation for the image, the annotators can be ranked based on their performance for the image, and their corresponding weights can be adjusted based on the ranking.

In effect, the weights can accurately reflect the expertise and performance of the annotators as the fine tuning step is performed across multiple FOVs of the image (e.g., 100 FOVs) or multiple images. In some instances, a particular annotator assigned with a low weight is retrained before being allowed to provide annotations for other images. Additionally or alternatively, annotations of the particular annotator assigned with the low weight can be removed from being used during the process to generate ground-truth labels for the image.

### D. Methods for Removing Annotation-Label Conflicts in an Image

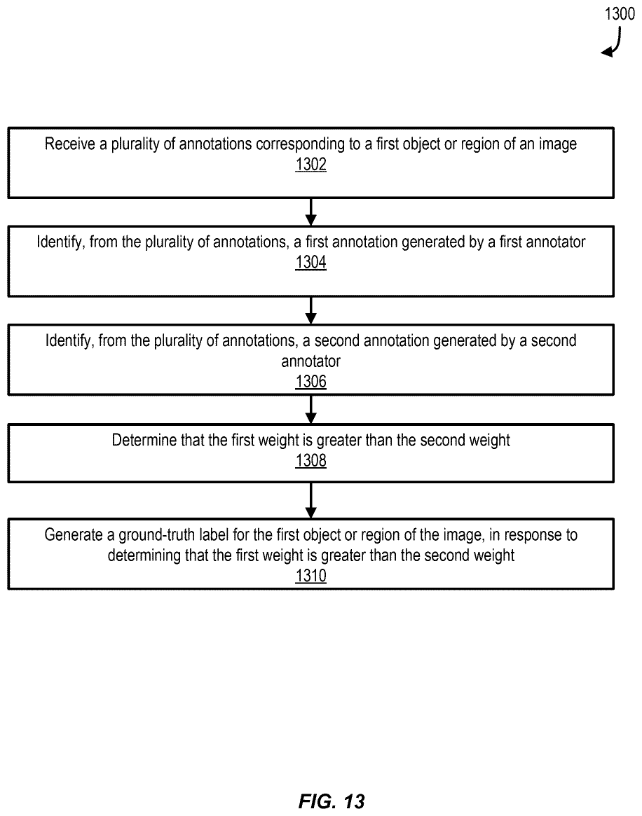

FIG. 13 illustrates a process 1300 for removing annotation-label conflicts and determining consensus labels in an image, in accordance with some embodiments. For illustrative purposes, the process 1300 is described with reference to the components illustrated in FIG. 1 and/or FIG. 3, though other implementations are possible. For example, the program code for the annotation-processing system 102 of FIG. 1 and/or the annotation-processing system 351 of FIG. 3, which is stored in a non-transitory computer-readable medium, is executed by one or more processing devices to cause a server system to perform one or more operations described herein.

At step 1302, the annotation-processing system receives a plurality of annotations corresponding to a first object or region of an image. The training image can be a digital pathology image depicting at least part of a biological sample (e.g., tissue) obtained from a subject. The plurality of annotations can be used to generate ground-truth labels for supervised training, validation, and/or testing of a machine-learning model. Each annotation of the set of annotations identifies a targeted type of a biological structure being depicted in the first object or region. For example, the targeted type of a biological structure includes a tumor cell, an immune cell, and the like. In some instances, each annotation includes an identifier associated with an annotator that generated the annotation.

At step 1304, the annotation-processing system identifies, from the plurality of annotations, a first annotation generated by a first annotator. The first annotation can identify a first targeted type of the biological structure (e.g., a tumor cell). In some instances, the first annotator is associated with a first weight. For example, a senior pathologist who has many years of experience can be assigned with a weight value that is greater than the weight value assigned to a junior pathologist who has little to no experience.

At step 1306, the annotation-processing system identifies, from the plurality of annotations, a second annotation generated by a second annotator. The second annotation identifies a second targeted type of the biological structure (e.g., an immune cell), in which the second targeted type is different from the first targeted type. The first and second annotations thus correspond to the same object or region, but indicate different targeted types of biological structure. In some instances, the second annotator is associated with a second weight, which can be the same or different from the first weight assigned to the first annotator.

At step 1308, the annotation-processing system determines that the first weight is greater than the second weight. Referring back to the above example, the first annotator can be a senior pathologist who has been assigned with the first weight that is greater than the second weight assigned to the second annotator who can be a junior pathologist.

At step 1310, the annotation-processing system generates a ground-truth label for the first object or region of the image, in response to determining that the first weight is greater than the second weight. The ground-truth label can identify the first targeted type of the biological structure. Continuing from the above example, the ground-truth label can include “a tumor cell” label. The ground-truth label at the consensus location can be used to train a machine-learning model that predicts a type of biological structure in corresponding regions of other slide images. The training of the machine-learning model using the ground-truth labels having consensus labels and locations can correspond to the training process described in FIG. 3. In some instances, the image with the generated ground-truth label is displayed on a graphical user interface.

In some instances, the annotation-processing system assesses whether the ground-truth label can be generated for the first object or region based on a confidence threshold. For example, the annotation-processing system can determine a statistical value (e.g., average, sum) based on the first weight and the second weight, and determine determining whether the statistical value exceeds the confidence threshold. In some instances, the confidence threshold includes a value that can be adjusted by one or more users. In response to determining that the statistical value does not exceed the confidence threshold, the annotation-processing system can generate an output that indicates that a consensus for the ground-truth label was not reached between the first and second annotators. The comparison of the weights against the confidence threshold can thus filter out annotations having low weighted values, which may be indicative of the consensus label not being sufficiently accurate.

In some instances, the annotation-processing system utilizes the assigned weights of the annotators to remove annotation-label conflicts occurring in three or more annotations. The annotation-processing system identifies, from the plurality of annotations, a third annotation generated by a third annotator. The third annotation identifies the second targeted type of the biological structure (e.g., the immune cell), and the third annotator is associated with a third weight. The annotation-processing system generates another statistical value based on the second weight and the third weight. The other statistical value is generated based on the second weight and the third weight, because both second and third annotations identify the same targeted type of the biological structure. In some instances, the other statistical value corresponds to a sum of the second and third weights. The annotation-processing system determines that the other statistical value is greater than the first weight, at which the annotation-processing system can redefine the ground-truth label for the first object or region of the image as identifying the second targeted type of the biological structure. Process 1300 terminates thereafter.

### VII. Additional Considerations

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

The ensuing description provides preferred exemplary embodiments only, and is not intended to limit the scope, applicability or configuration of the disclosure. Rather, the ensuing description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the following description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

What is claimed is:

1. A method comprising:
accessing a plurality of annotations associated with an image at a location that identifies an object or region within the image, wherein the plurality of annotations are used to generate ground-truth labels for supervised training, validation, and/or testing of a machine-learning model, wherein each annotation of the plurality of annotations is positioned within the training image at a location that identifies an object or region within the training image, and wherein each annotation includes an identifier associated with an annotator that generated the annotation;
identifying, from the plurality of annotations, a first annotation generated by a first annotator and a second annotation generated by a second annotator;
determining a first distance value between a first location of the first annotation and a second location of the second annotation;
determining that the first distance value is below a predetermined threshold;
in response to determining that the first distance value is below the predetermined threshold, determining the first annotation and the second annotation as both identifying a first object or region within the image;
identifying, from the plurality of annotations, a third annotation generated by the first annotator, wherein the third annotation is positioned at a third location that is different from the first location;
determining that a second distance value between the second location of the second annotation and the third location of the third annotation is below the predetermined threshold;
in response to determining that the second distance value is below the predetermined threshold, determining the third annotation as also identifying the first object or region within the image; and
in response to determining the third annotation as identifying the first object or region within the image, generating an output indicating that the object or region within the image has an annotation conflict.

1. The method of claim 1, further comprising:
determining that the first distance value is less than the second distance value;
determining that the third annotation as identifying a second object or region within the image; and
generating another output that the annotation conflict has been resolved.

2. The method of claim 1, further comprising:
identifying, from the plurality of annotations, a fourth annotation generated by the second annotator, wherein the fourth annotation is positioned at a fourth location of the image that is different from the second location of the second annotation;
determining a third distance value between the third location and the fourth location;
determining that the third distance value is below the predetermined threshold;
in response to determining that the third distance value is below the predetermined threshold, determining the third annotation and fourth annotation as both identifying the first object or region within the image;
applying a clustering algorithm to the first location, the second location, the third location, and the fourth location to determine that: (i) the first annotation and the second annotation correspond to a first subregion of the first object or region; and (ii) the third annotation and the fourth annotation correspond to a second subregion of the first object or region.

3. The method of claim 3, wherein the clustering algorithm includes a k-means clustering algorithm.

4. The method of claim 1, wherein the first object or region depicts a biological structure.

5. The method of claim 5, wherein:
the first annotation further identifies a targeted type of the biological structure depicted in the first object or region; and
the second annotation further identifies the targeted type of the biological structure depicted in the first object or region.

6. The method of claim 6, further comprising:
generating a ground-truth label for the first object or region within the image, wherein the ground-truth label includes the targeted type of the biological structure; and
providing the image with the ground-truth label to perform supervised training of the machine-learning model to predict whether another biological structure depicted in another image corresponds to the targeted type of the biological structure.

7. The method of claim 6, wherein the targeted type of the biological structure corresponds to a stained tumor cell, an unstained tumor cell, or a normal cell.

8. A method comprising:
receiving a plurality of annotations corresponding to a first object or region of an image, wherein the image depicts at least part of a tissue sample, wherein the plurality of annotations are used to generate ground-truth labels for supervised training, validation, and/or testing of a machine-learning model, wherein each annotation of the set of annotations identifies a targeted type of a biological structure being depicted in the first object or region, and wherein each annotation includes an identifier associated with an annotator that generated the annotation;
identifying, from the plurality of annotations, a first annotation generated by a first annotator, wherein the first annotation identifies a first targeted type of the biological structure, and wherein the first annotator is associated with a first weight;
identifying, from the plurality of annotations, a second annotation generated by a second annotator, wherein the second annotation identifies a second targeted type of the biological structure, wherein the second annotator is associated with a second weight, and wherein the first targeted type is different from the second targeted type;
determining that the first weight is greater than the second weight; and
in response to determining that the first weight is greater than the second weight, generating a ground-truth label for the first object or region of the image, wherein the ground-truth label identifies the first targeted type of the biological structure.

9. The method of claim 9, further comprising:
determining a statistical value based on the first weight and the second weight; and
determining whether the statistical value exceeds a confidence threshold.

10. The method of claim 10, further comprising:
in response to determining that the statistical value does not exceed the confidence threshold, generating an output that indicates that a consensus for the ground-truth label was not reached between the first and second annotators.

11. The method of claim 10, further comprising:
determining that the statistical value exceeds a confidence threshold; and
in response to determining that the statistical value exceeds the confidence threshold, generating an output that indicates that a consensus for the ground-truth label was reached between the first and second annotators.

12. The method of claim 9, wherein:
receiving an input from a user; and
adjusting the first weight and/or the second weight based on the input.

13. The method of claim 9, further comprising:
identifying, from the plurality of annotations, a third annotation generated by a third annotator, wherein the third annotation identifies the second targeted type of the biological structure, and wherein the third annotator is associated with a third weight;
generating another statistical value based on the second weight and the third weight;
determining that the other statistical value is greater than the first weight; and
in response to determining that the other statistical value is greater than the first weight, redefining the ground-truth label for the first object or region of the image as identifying the second targeted type of the biological structure.

14. The method of claim 9, further comprising:
providing the image with the ground-truth label to train the machine-learning model, wherein the machine-learning model is trained to predict whether another biological structure depicted in another image corresponds to the first targeted type of the biological structure.

15. The method of claim 9, further comprising displaying the image with the ground-truth label on a graphical user interface.

16. A system comprising:
one or more data processors; and
a non-transitory computer readable storage medium containing instructions which, when executed on the one or more data processors, cause the one or more data processors to perform a set of operations including:
accessing a plurality of annotations associated with an image at a location that identifies an object or region within the image, wherein the plurality of annotations are used to generate ground-truth labels for supervised training, validation, and/or testing of a machine-learning model, wherein each annotation of the plurality of annotations is positioned within the training image at a location that identifies an object or region within the training image, and wherein each annotation includes an identifier associated with an annotator that generated the annotation;
identifying, from the plurality of annotations, a first annotation generated by a first annotator and a second annotation generated by a second annotator;
determining a first distance value between a first location of the first annotation and a second location of the second annotation;
determining that the first distance value is below a predetermined threshold;
in response to determining that the first distance value is below the predetermined threshold, determining the first annotation and the second annotation as both identifying a first object or region within the image;
identifying, from the plurality of annotations, a third annotation generated by the first annotator, wherein the third annotation is positioned at a third location that is different from the first location;
determining that a second distance value between the second location of the second annotation and the third location of the third annotation is below the predetermined threshold;
in response to determining that the second distance value is below the predetermined threshold, determining the third annotation as also identifying the first object or region within the image; and
in response to determining the third annotation as identifying the first object or region within the image, generating an output indicating that the object or region within the image has an annotation conflict.

18. A computer-program product tangibly embodied in a non-transitory machine-readable storage medium, including instructions configured to cause one or more data processors to perform a set of operations including:
accessing a plurality of annotations associated with an image at a location that identifies an object or region within the image, wherein the plurality of annotations are used to generate ground-truth labels for supervised training, validation, and/or testing of a machine-learning model, wherein each annotation of the plurality of annotations is positioned within the training image at a location that identifies an object or region within the training image, and wherein each annotation includes an identifier associated with an annotator that generated the annotation;
identifying, from the plurality of annotations, a first annotation generated by a first annotator and a second annotation generated by a second annotator;
determining a first distance value between a first location of the first annotation and a second location of the second annotation;
determining that the first distance value is below a predetermined threshold;
in response to determining that the first distance value is below the predetermined threshold, determining the first annotation and the second annotation as both identifying a first object or region within the image;
identifying, from the plurality of annotations, a third annotation generated by the first annotator, wherein the third annotation is positioned at a third location that is different from the first location;
determining that a second distance value between the second location of the second annotation and the third location of the third annotation is below the predetermined threshold;
in response to determining that the second distance value is below the predetermined threshold, determining the third annotation as also identifying the first object or region within the image; and
in response to determining the third annotation as identifying the first object or region within the image, generating an output indicating that the object or region within the image has an annotation conflict.

19. The computer-program product of claim 18 wherein the set of operations further includes:
determining that the first distance value is less than the second distance value;
determining that the third annotation as identifying a second object or region within the image; and
generating another output that the annotation conflict has been resolved.

20. A computer-program product tangibly embodied in a non-transitory machine-readable storage medium, including instructions configured to cause one or more data processors to perform a set of operations including:
receiving a plurality of annotations corresponding to a first object or region of an image, wherein the image depicts at least part of a tissue sample, wherein the plurality of annotations are used to generate ground-truth labels for supervised training, validation, and/or testing of a machine-learning model, wherein each annotation of the set of annotations identifies a targeted type of a biological structure being depicted in the first object or region, and wherein each annotation includes an identifier associated with an annotator that generated the annotation;
identifying, from the plurality of annotations, a first annotation generated by a first annotator, wherein the first annotation identifies a first targeted type of the biological structure, and wherein the first annotator is associated with a first weight;
identifying, from the plurality of annotations, a second annotation generated by a second annotator, wherein the second annotation identifies a second targeted type of the biological structure, wherein the second annotator is associated with a second weight, and wherein the first targeted type is different from the second targeted type;
determining that the first weight is greater than the second weight; and
in response to determining that the first weight is greater than the second weight, generating a ground-truth label for the first object or region of the image, wherein the ground-truth label identifies the first targeted type of the biological structure.
